(19) United States
(12) Patent Application Publication
(10) Pub. No.: US 2026/0318590 A1
(43) Pub. Date: Oct. 15, 2026

(54) REFRIGERATOR

(71) Applicant: SAMSUNG ELECTRONICS CO., LTD., Suwon-si (KR)

(72) Inventors: Donggun KO, Suwon-si (KR); Dongpil SEO, Suwon-si (KR)

(73) Assignee: SAMSUNG ELECTRONICS CO., LTD., Suwon-si (KR)

(21) Appl. No.: 19/467,358

(22) Filed: Feb. 2, 2026

Related U.S. Application Data
(63) Continuation of application No. PCT/KR2026/000710, filed on Jan. 13, 2026.

(30) Foreign Application Priority Data
Feb. 14, 2025 (KR) 10-2025-0019718

(51) Int. Cl. F25D 23/06

(52) U.S. Cl. CPC F25D 23/065; F25D 23/062; F25D 2201/14

(57) ABSTRACT

A refrigerator comprises an inner case in which a storage compartment is inside; an outer case; and an insulating pad, including a plurality of insulating members along an edge of the inner case. At least one of the plurality of insulating members is arranged to contact with at least one other of the plurality of insulating members to form a contact surface. The contact surface comprises: a first contact portion extending from an inner surface of the insulating pad toward an outer surface of the insulating pad; a second contact portion extending from the outer surface of the insulating pad toward the inner surface of the insulating pad; and a third contact portion extending in a direction intersecting the first contact portion and the second contact portion such that the first contact portion and the second contact portion connect to each other.

### CROSS REFERENCE TO THE RELATED APPLICATION

This application is a continuation application, filed under 35 U.S.C. §111(a), of International Application PCT/KR2026/000710 filed January 13, 2026, and is based on and claims priority under 35 U.S.C. §119 to Korean Patent Applications No. 10-2025-0019718, filed on February 14, 2025 in the Korean Intellectual Property Office, the disclosures of which are incorporated by reference herein in their entireties.

### TECHNICAL FIELD

The present disclosure relates to a refrigerator including an improved structure.

### BACKGROUND ART

A refrigerator is a device that keeps food fresh by including a main body including a storage compartment and a cold air supply system configured to supply cold air to the storage compartment. The storage compartment includes a refrigerating compartment that maintains a temperature of approximately 0 to 5 degrees Celsius to refrigerate food, and a freezing compartment that maintains a temperature of approximately 0 to -30 degrees Celsius to freeze food.

The main body of the refrigerator body is formed by coupling an inner case and an outer case. The inner case forms the storage compartment, and the outer case forms an exterior of the refrigerator. An insulating member is disposed between the inner and outer cases for insulation.

The insulating member may include an insulating material such as urethane or an insulating panel such as a vacuum insulating panel.

### DISCLOSURE

### Technical Problem

The present disclosure is directed to providing a refrigerator including an insulating pad in the form of a plurality of insulating members bonded to each other.

Further, the present disclosure is directed to providing a refrigerator having a high insulation effect by forming a relatively long path through which heat leaks from a storage compartment to an outside of the refrigerator.

Additional aspects of the disclosure will be set forth in part in the description which follows and, in part, will be obvious from the description, or may be learned by practice of the disclosure.

### Technical Solution

One aspect of the present disclosure provides a refrigerator including an inner case in which a storage compartment is provided; an outer case provided on an outside of the inner case; and an insulating pad provided between the inner case and the outer case, and including a plurality of insulating members arranged along an edge of the inner case. At least some of the plurality of insulating members are arranged to come into contact with each other so as to form a contact surface. The contact surface includes a first contact portion extending from an inner surface of the insulating pad toward an outer surface of the insulating pad, a second contact portion extending from the outer surface of the insulating pad toward the inner surface of the insulating pad, and a third contact portion extending in a direction intersecting each of the first contact portion and the second contact portion so as to connect the first contact portion and the second contact portion.

Another aspect of the present disclosure provides a refrigerator including an inner case in which a storage compartment is provided; an outer case provided on an outside of the inner case; and an insulating pad provided between the inner case and the outer case, and including a plurality of insulating panel provided to come into contact with each other. The insulating pad includes a first insulating panel layer including some of the plurality of insulating panels, and provided to allow some of the plurality of insulating panels to be arranged along an edge of the inner case to cover the inner case, and a second insulating panel layer including others of the plurality of insulating panels and provided to allow others of the plurality of insulating panels to be arranged along an outer surface of the first insulating panel layer to cover the first insulating panel layer.

Another aspect of the present disclosure provides a refrigerator including: an inner case in which a storage compartment is inside; an outer case on an outside of the inner case; and an insulating pad, between the inner case and the outer case, including a plurality of insulating members arranged along an edge of the inner case, wherein at least one of the plurality of insulating members is arranged to contact with at least one other of the plurality of insulating members so as to form a contact surface, wherein the contact surface includes: a first contact portion extending from an inner surface of the insulating pad in a first direction toward an outer surface of the insulating pad; a second contact portion extending from the outer surface of the insulating pad in a second direction opposite the first direction and toward the inner surface of the insulating pad; and a third contact portion extending in a third direction intersecting the first contact portion and intersecting the second contact portion such that the first contact portion and the second contact portion connect to each other, wherein the third direction is both perpendicular to the first direction and perpendicular to the second direction.

### DESCRIPTION OF DRAWINGS

FIG. 1 is a perspective view illustrating a refrigerator according to one embodiment.

FIG. 2 is a perspective view illustrating a state in which an inner case, an outer case, and an insulating pad of the refrigerator according to one embodiment are exploded.

FIG. 3 is a cross-sectional view illustrating a state in which the inner case, the outer case, and the insulating pad of the refrigerator according to one embodiment are coupled to each other.

FIG. 4 is a cross-sectional view of an insulating panel according to one embodiment.

FIG. 5 is an enlarged view of a region A illustrated in FIG. 3.

FIG. 6 is an enlarged view of the region A illustrated in FIG. 3.

FIG. 7 is a cross-sectional view illustrating a state in which an inner case, an outer case, and an insulating pad of a refrigerator according to one embodiment are coupled to each other.

FIG. 8 is a cross-sectional view illustrating a state in which an inner case, an outer case, and an insulating pad of a refrigerator according to one embodiment are coupled to each other.

FIG. 9 is an enlarged view of a region B illustrated in FIG. 8.

FIG. 10 is a cross-sectional view illustrating a state in which an inner case, an outer case, and an insulating pad of a refrigerator according to one embodiment are coupled to each other.

FIG. 11 is a cross-sectional view of an insulating panel according to one embodiment.

FIG. 12 is an enlarged view of a region C illustrated in FIG. 10.

### MODES OF THE INVENTION

Various embodiments of the disclosure and terms used herein are not intended to limit the technical features described herein to specific embodiments, and should be understood to include various modifications, equivalents, or substitutions of the corresponding embodiments.

In describing of the drawings, similar reference numerals may be used for similar or related elements.

The singular form of a noun corresponding to an item may include one or more of the items unless clearly indicated otherwise in a related context.

In the disclosure, phrases, such as “A or B”, “at least one of A and B”, “at least one of A or B”, “A, B or C”, “at least one of A, B and C”, and “at least one of A, B, or C” may include any one or all possible combinations of the items listed together in the corresponding phrase among the phrases.

As used herein, the term “and/or” includes any and all combinations of one or more of the associated listed items.

Terms such as “1st”, “2nd”, “primary”, or “secondary” may be used simply to distinguish an element from other elements, without limiting the element in other aspects (e.g., importance or order).

Further, as used in the disclosure, the terms “front”, “rear”, “top”, “bottom”, “side”, “left”, “right”, “upper”, “lower”, and the like are defined with reference to the drawings, and are not intended to limit the shape and position of any element.

It will be understood that when the terms “includes”, “comprises”, “including”, and/or “comprising” are used in the disclosure, they specify the presence of the specified features, figures, steps, operations, components, members, or combinations thereof, but do not preclude the presence or addition of one or more other features, figures, steps, operations, components, members, or combinations thereof.

When a given element is referred to as being “connected to”, “coupled to”, “supported by” or “in contact with” another element, it is to be understood that it may be directly or indirectly connected to, coupled to, supported by, or in contact with the other element. When a given element is indirectly connected to, coupled to, supported by, or in contact with another element, it is to be understood that it may be connected to, coupled to, supported by, or in contact with the other element through a third element.

It will also be understood that when an element is referred to as being “on” another element, it may be directly on the other element or intervening elements may also be present.

A refrigerator according to an embodiment of the disclosure may include a main body.

The “main body” may include an inner case, an outer case positioned outside the inner case, and an insulating material provided between the inner case and the outer case.

The “inner case” may include a case, a plate, a panel, or a liner forming a storage compartment (also referred to as a storage room). The inner case may be formed as one body, or may be formed by assembling a plurality of plates together. The “outer case” may form an appearance of the main body, and be coupled to an outer side of the inner case such that the insulating material is positioned between the inner case and the outer case.

The “insulating material” may insulate an inside of the storage compartment from an outside of the storage compartment to maintain inside temperature of the storage compartment at appropriate temperature without being influenced by an external environment of the storage compartment. According to an embodiment of the disclosure, the insulating material may include a foaming insulating material. The foaming insulating material may be molded by fixing the inner case and the outer case with jigs, etc. and then injecting and foaming urethane foam as a mixture of polyurethane and a foaming agent between the inner case and the outer case.

According to an embodiment of the disclosure, the insulating material may include a vacuum insulating material in addition to a foaming insulating material, or may be configured only with a vacuum insulating material instead of a forming insulating material. The vacuum insulating material may include a core material and a cladding material accommodating the core material and sealing the inside with vacuum or pressure close to vacuum. However, the insulating material is not limited to the above-mentioned foaming insulating material or vacuum insulating material, and may include various materials capable of being used for insulation.

The “storage compartment” may include a space defined by the inner case. The storage compartment may further include the inner case defining the space corresponding to the storage compartment. The storage compartment may store a variety of items, such as food, medicines, cosmetics, and the like, and the storage compartment may be configured to be open on at least one side for insertion and removal of the items.

The refrigerator may include one or more storage compartments. In a case in which two or more storage compartments are formed in the refrigerator, the respective storage compartments may have different purposes of use, and may be maintained at different temperatures. To this end, the respective storage compartments may be partitioned by a partition wall including an insulating material.

The storage compartment may be maintained within an appropriate temperature range according to a purpose of use, and may include a “refrigerating compartment”, a “freezing compartment”, and a “temperature conversion compartment” according to purposes of use and/or temperature ranges. The refrigerating compartment may be maintained at an appropriate temperature to keep food refrigerating, and the freezing compartment may be maintained at an appropriate temperature to keep food frozen. The “refrigerating” may be keeping food cold without freezing the food, and for example, the refrigerating compartment may be maintained within a range of 0 degrees Celsius to 7 degrees Celsius. The “freezing” may be freezing food or keeping food frozen, and for example, the freezing compartment may be maintained within a range of -20 degrees Celsius to -1 degrees Celsius. The temperature conversion compartment may be used as either a refrigerating compartment or a freezing compartment according to or regardless of a user's selection.

The storage compartment may also be referred to by various terms, such as “vegetable compartment”, “freshness compartment”, “cooling compartment”, and “ice-making compartment”, in addition to “refrigerating compartment”, “freezing compartment”, and “temperature conversion compartment”, and the terms, such as “refrigerating compartment”, “freezing compartment”, “temperature conversion compartment”, etc., as used below are to be understood as representing storage compartments having the corresponding purposes of use and the corresponding temperature ranges.

The refrigerator according to an embodiment of the disclosure may include at least one door configured to open or close the open side of the storage compartment. The respective doors may be provided to open and close one or more storage compartments, or a single door may be provided to open and close a plurality of storage compartments. The door may be rotatably or slidably mounted to the front of the main body.

The “door” may seal the storage compartment in a closed state. The door, like the main body, may include an insulating material to insulate the storage compartment in a closed state.

According to an embodiment, the door may include an outer door plate forming the front surface of the door, an inner door plate forming the rear surface of the door and facing the storage compartment, an upper cap, a lower cap, and a door insulating material provided therein.

A gasket may be provided on the edge of the inner door plate to seal the storage compartment by coming into close contact with the front surface of the main body when the door is closed. The inner door plate may include a dyke that protrudes rearward to allow a door basket for storing items to be fitted.

According to an embodiment, the door may include a door body and a front panel that is detachably coupled to the front of the door body and forming the front surface of the door. The door body may include an outer door plate forming the front surface of the door body, an inner door plate forming the rear surface of the door body and facing the storage compartment, an upper cap, a lower cap, and a door insulator provided therein.

The refrigerator may be classified as French Door Type, Side-by-side Type, Bottom Mounted Freezer (BMF), Top Mounted Freezer (TMF), or Single Door Refrigerator according to the arrangement of the doors and the storage compartments.

The refrigerator according to an embodiment of the disclosure may include a cold air supply device for supplying cold air to the storage compartment.

The “cold air supply device” may include a machine, an apparatus, an electronic device, and/or a combination system thereof, capable of generating cold air and guiding the cold air to cool the storage compartment.

According to an embodiment of the disclosure, the cold air supply device may generate cold air through a cooling cycle including compression, condensation, expansion, and evaporation processes of refrigerants. To this end, the cold air supply device may include a refrigeration cycle device having a compressor, a condenser, an expander, and an evaporator to drive the refrigeration cycle. According to an embodiment of the disclosure, the cold air supply device may include a semiconductor, such as a thermoelectric element. The thermoelectric element may cool the storage compartment by heating and cooling actions through the Peltier effect.

The refrigerator according to an embodiment of the disclosure may include a machine compartment in which at least some components belonging to the cold air supply device are installed.

The “machine compartment” may be partitioned and insulated from the storage compartment to prevent heat generated by the components installed in the machine compartment from being transferred to the storage compartment. To dissipate heat from the components installed in the machine compartment, the machine compartment may communicate with outside of the main body.

The refrigerator according to an embodiment of the disclosure may include a dispenser provided on the door to provide water and/or ice. The dispenser may be provided on the door to allow access by the user without opening the door.

The refrigerator according to an embodiment of the disclosure may include an ice-making device that produces ice. The ice-making device may include an ice-making tray that stores water, an ice-moving device that separates ice from the ice-making tray, and an ice-bucket that stores ice produced in the ice-making tray.

The refrigerator according to an embodiment of the disclosure may include a controller for controlling the refrigerator.

The “controller” may include a memory for storing and/or recording data and/or programs for controlling the refrigerator, and a processor for outputting control signals for controlling the cold air supply device, etc. in accordance with the programs and/or data stored in the memory.

The memory may store or record various information, data, instructions, programs, and the like necessary for operation of the refrigerator. The memory may store temporary data generated while generating control signals for controlling components included in the refrigerator. The memory may include at least one of a volatile memory or a non-volatile memory, or a combination thereof.

The processor may control the overall operation of the refrigerator. The processor may control the components of the refrigerator by executing programs stored in memory. The processor may include a separate neural processing unit (NPU) that performs an artificial intelligence (AI) model operation. In addition, the processor may include a central processing unit (CPU), a graphics processor (GPU), and the like. The processor may generate a control signal to control the operation of the cold air supply device. For example, the processor may receive temperature information of the storage compartment from a temperature sensor and generate a cooling control signal to control an operation of the cold air supply device based on the temperature information of the storage compartment.

Furthermore, the processor may process a user input of a user interface and control an operation of the user interface in accordance with the programs and/or data memorized/stored in the memory. The user interface may be provided with an input interface and an output interface. The processor may receive the user input from the user interface. In addition, the processor may transmit a display control signal and image data for displaying an image on the user interface to the user interface in response to the user input.

The processor and memory may be provided integrally or may be provided separately. The processor may include one or more processors. For example, the processor may include a main processor and at least one sub-processor. The memory may include one or more memories.

The refrigerator according to an embodiment of the disclosure may include a processor and a memory for controlling all of the components included in the refrigerator, and may include a plurality of processors and a plurality of memories for individually controlling the components of the refrigerator. For example, the refrigerator may include a processor and a memory for controlling the operation of the cold air supply device in accordance with to an output of the temperature sensor. In addition, the refrigerator may be separately provided with a processor and a memory for controlling the operation of the user interface in accordance with the user input.

A communication module may communicate with external devices, such as servers, mobile devices, and other home appliances via a nearby access point (AP). The AP may connect a local area network (LAN) to which a refrigerator or a user device is connected to a wide area network (WAN) to which a server is connected. The refrigerator or the user device may be connected to the server via the WAN.

The input interface may include keys, a touch screen, a microphone, and the like. The input interface may receive the user input and pass the received user input to the processor.

The output interface may include a display, a speaker, and the like. The output interface may output various notifications, messages, information, and the like generated by the processor.

Meanwhile, the terms “front and rear direction,” “left and right direction,” “upper side,” “lower side,” and the like used in the description below are defined based on the drawing, and the shape and position of each component are not limited by these terms.

For example, a X direction may be defined as a front and rear direction. For example, a Y direction may be defined a lateral direction. For example, a Z direction may be defined as an up and down direction. For example, a +X direction may be defined as a front side, and a -X direction may be defined as a rear side. For example, a +Y direction may be defined as a right side, and a -Y direction may be defined as a left side. For example, a +Z direction may be defined as an upper side, and a -Z direction may be defined as a lower side.

Hereinafter exemplary embodiments of the present disclosure will be described in detail with reference to the accompanying drawings.

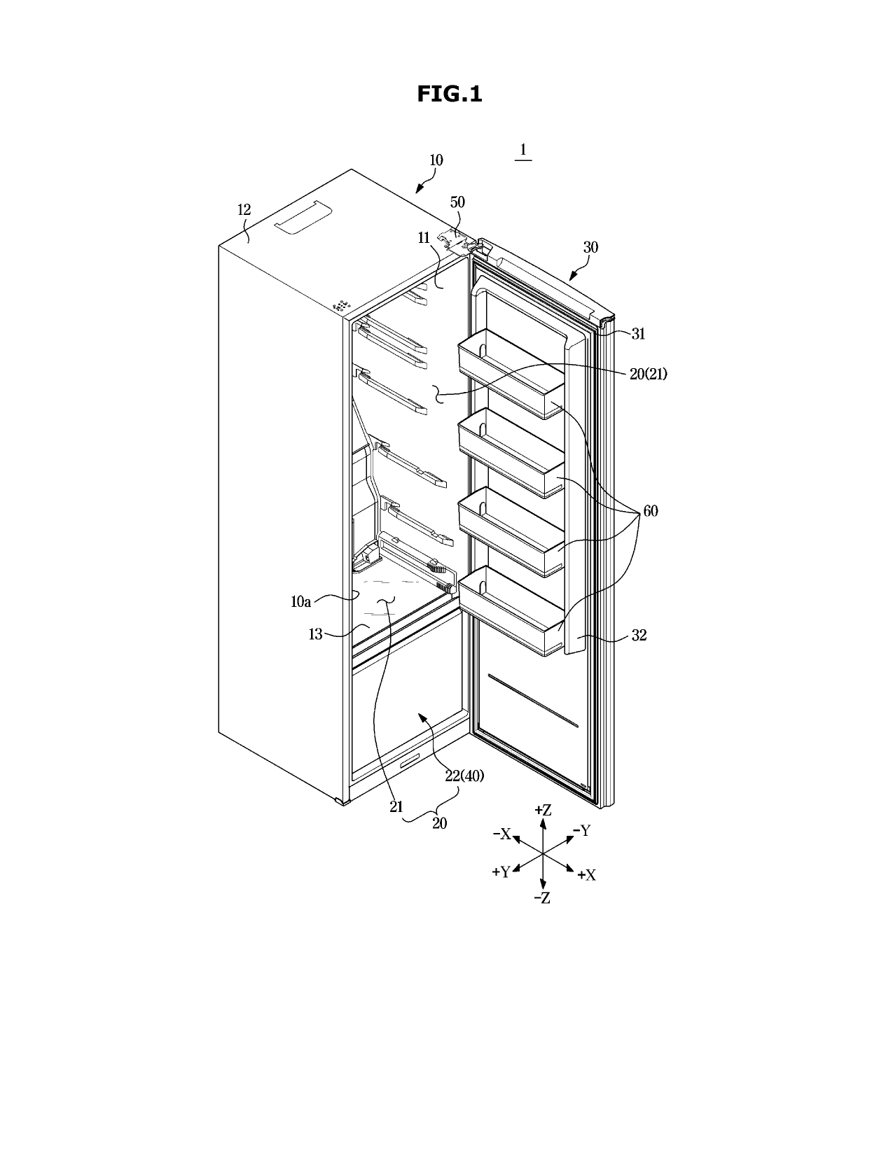

FIG. 1 is a perspective view illustrating a refrigerator according to one embodiment.

Referring to FIG. 1, a refrigerator 1 may include a main body 10, a storage compartment 20 provided inside the main body 10, a door 30 configured to open and close the storage compartment 20, and a cooling system for supplying cold air to the storage compartment 20.

The main body 10 may be formed with an open front surface to allow a user to put food into and take the food out of the storage compartment 20. That is, the main body 10 may include an opening 10a formed on the front surface of the main body 10. The opening 10a of the main body 10 may be opened and closed by a door 30.

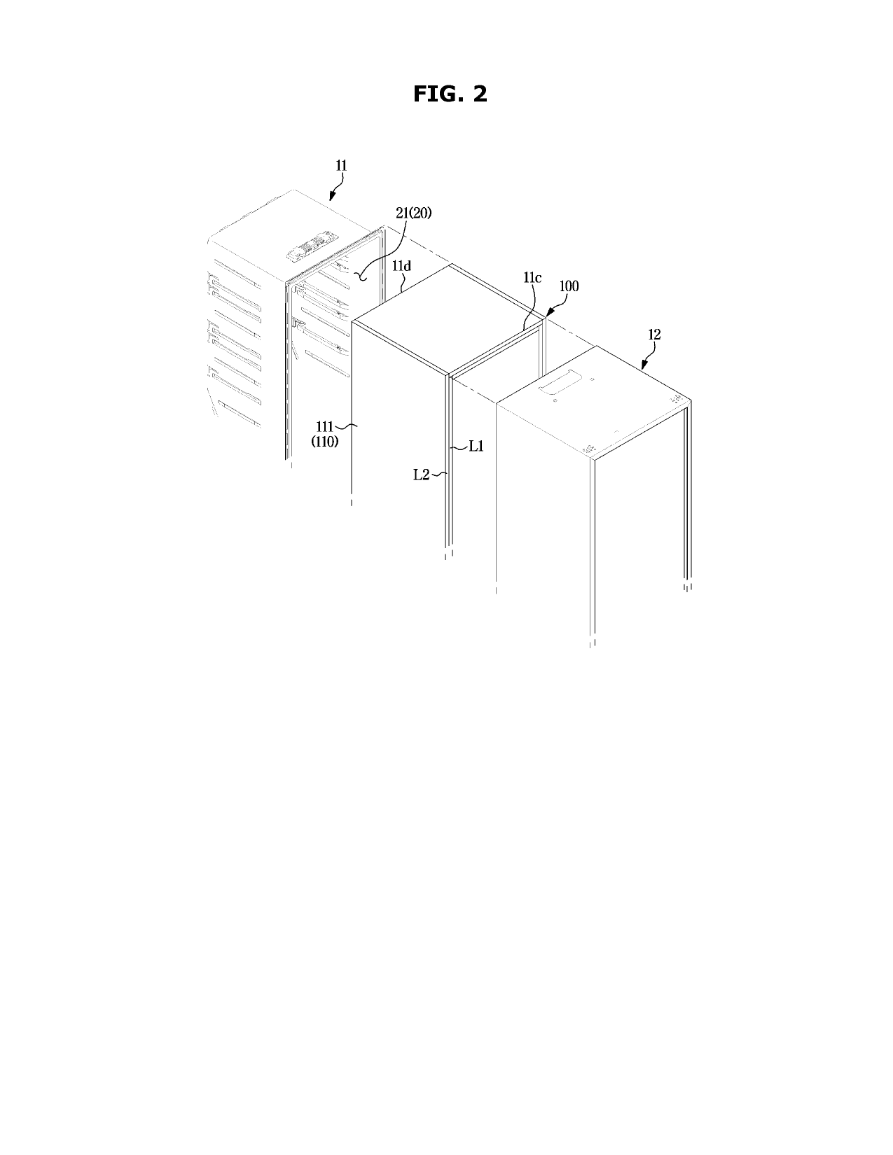

The main body 10 may include an inner case 11 forming the storage compartment 20, an outer case 12 forming an exterior of the refrigerator 1, and an insulating pad 100 (refer to FIG. 2) provided between the inner case 11 and the outer case 12.

A front surface of the inner case 11 may be open. The storage compartment 20 may be provided inside the inner case 11. An inner surface of the inner case 11 may form an inner wall of the storage compartment 20.

The inner case 11 may be formed to include a plastic material. For example, the inner case 11 may be manufactured by a vacuum forming process. For example, the inner case 11 may be manufactured by an injection molding process.

The outer case 12 may be provided on an outside of the inner case 11. For example, the outer case 12 may be coupled to the outside of the inner case 11.

The outer case 12 may be formed to have a shape of a box with an open front surface. The outer case 12 may form upper and lower surfaces, left and right surfaces, and a rear surface of the refrigerator 1. An outer surface of the outer case 12 may form an outer wall of the refrigerator 1.

The outer case 12 may be formed to include a metal material. For example, the outer case 12 may be manufactured by processing a steel plate material.

The storage compartment 20 may be formed inside the main body 10. The storage compartment 20 may include an upper storage compartment 21 provided relatively on the upper side and a lower storage compartment 22 provided relatively on the lower side. The upper storage compartment 21 and the lower storage compartment 22 may be partitioned by a partition wall 13.

For example, the upper storage compartment 21 may be a refrigerating compartment that is maintained at approximately 0 to 5 degrees Celsius and stores food in a cold state, and the lower storage compartment 22 may be a freezing compartment that is maintained at approximately -30 to 0 degrees Celsius and stores food in a frozen state. However, the locations of the refrigerating compartment and the freezing compartment are not limited thereto.

According to embodiments, the refrigerator 1 may be Side By Side (SBS) type in which the storage compartment 20 is partitioned into the left and right sides by a vertical partition, French Door Refrigerator (FDR) type in which the storage compartment 20 is partitioned into the upper and lower sides by a horizontal partition, or one door type including one storage compartment and one door.

The upper storage compartment 21 may be provided with a shelf (not shown) for placing food and a storage container (not shown) for storing food.

The main body 10 may include a storage compartment case 40. The lower storage compartment 22 may be formed inside the storage compartment case 40. The storage compartment case 40 may be configured to be inserted into or withdrawn from the inside of the main body 10. However, the storage compartment case 40 may be omitted, and in this case, a front surface of the lower storage compartment 22 may be opened.

The refrigerator 1 may include the door 30. The storage compartment 20 may be opened and closed by the door 30. Particularly, each of the upper storage compartment 21 and the lower storage compartment 22 may be opened and closed by the door 30.

The door 30 may be rotatably coupled to the main body 10. For example, the door 30 may be rotatably coupled to the main body 10 by a hinge 50.

The door 30 may include a gasket 31. The gasket 31 may be provided on a rear surface of the door 30. Particularly, the gasket 31 may be provided along an edge of the rear surface of the door 30. The gasket 31 may include an elastic material.

When the door 30 is closed, the gasket 31 may be pressed against the front surface of the main body 10. With this configuration, the gasket 31 may seal between the door 30 and the front surface of the main body 10.

The door 30 may include a dike 32. The dike 32 may protrude from the rear surface of the door 30. The dike 32 may be provided to support a door basket 60 to be described later.

The refrigerator 1 may include the door basket 60. The door basket 60 may form a storage space for storing items. The door basket 60 may be provided at the rear surface of the door 30.

The refrigerator 1 may include a refrigeration system configured to generate cold air using a refrigeration cycle and configured to supply the generated cold air to the storage compartment 20.

The refrigeration system may generate cold air by utilizing latent heat of vaporization of a refrigerant generated during the refrigeration cycle. The refrigeration system may include a compressor, a condenser, an expansion valve, and an evaporator.

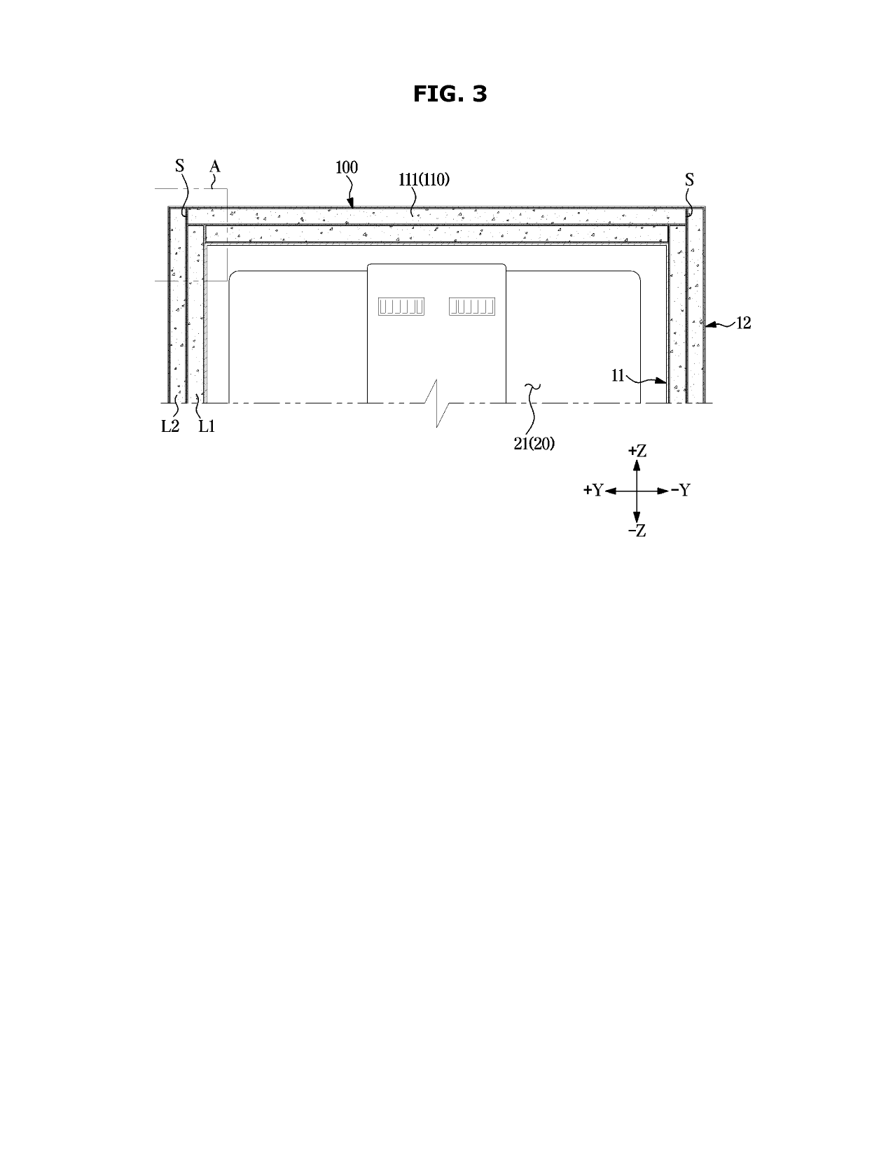

FIG. 2 is a perspective view illustrating a state in which an inner case, an outer case, and an insulating pad of the refrigerator according to one embodiment are exploded. FIG. 3 is a cross-sectional view illustrating a state in which the inner case, the outer case, and the insulating pad of the refrigerator according to one embodiment are coupled to each other.

Referring to FIGS. 2 and 3, the refrigerator 1 may include the insulating pad 100. The insulating pad 100 may be provided to insulate the storage compartment 20.

The insulating pad 100 may be provided between the inner case 11 and the outer case 12. Particularly, an inner surface of the insulating pad 100 may come into contact with an outer surface of the inner case 11, and an outer surface of the insulating pad 100 may come into contact with an inner surface of the outer case 12. The insulating pad 100 may have a shape corresponding to a space between the inner case 11 and the outer case 12.

The insulating pad 100 may be coupled to each of the inner case 11 and the outer case 12. Particularly, the insulating pad 100 may be not foamed between the inner case 11 and the outer case 12, but may be coupled to each of the inner case 11 and the outer case 12, thereby being provided between the inner case 11 and the outer case 12. That is, the insulating pad 100 may be a single module (or unit) distinct from the inner case 11 and the outer case 12. With this configuration, an assembly process of the refrigerator 1 may be further simplified.

The insulating pad 100 may include a plurality of insulating members 110. Each of the plurality of insulating members 110 may have relatively low thermal conductivity.

The plurality of insulating members 110 may be arranged along an edge of the inner case 11. In other words, the plurality of insulating members 110 may be arranged along an edge of the outer case 12. For example, the plurality of insulating members 110 may be arranged along an upper wall, a lower wall, a left wall, and/or a right wall of the inner case 11.

At least some of the plurality of insulating members 110 may be stacked along a direction intersecting a direction in which the plurality of insulating members 110 is arranged. For example, two or more insulating members 110 may be stacked between one side wall of the inner case 11 and one side wall of the outer case 12.

At least some of the plurality of insulating members 110 may be arranged to come into contact with each other so as to form a contact surface S. For example, two insulating members 110 arranged adjacently may come into contact with each other.

The plurality of insulating members 110 may be bonded to each other so as to be provided integrally. With this configuration, the insulating pad 100 may be provided as a single module.

The plurality of insulating members 110 may include an insulating panel 111. The insulating panel 111 may be one configuration that has relatively low thermal conductivity and is provided in a panel shape. The insulating panel 111 may be provided in an approximately hexahedral shape.

A plurality of the insulating panel 111 may be provided. The plurality of insulating panels 111 may be arranged along the edge of the inner case 11. At least some of the plurality of insulating panels 111 may be stacked in a direction intersecting the direction in which the plurality of insulating members 110 is arranged. At least some of the plurality of insulating panels 111 may be provided to come into contact with each other. The plurality of insulating panels 111 may be bonded to each other so as to be provided integrally.

As described above, the plurality of insulating panels 111 may be arranged along the edge of the inner case 11, and at least some of the plurality of insulating panels 111 may be stacked along the direction intersecting the direction in which the plurality of insulating members 110 is arranged. Due the configuration, the plurality of insulating panels 111 may form a plurality of layers. For example, the insulating pad 100 may include a first insulating panel layer L1 and a second insulating panel layer L2.

The first insulating panel layer L1 may cover the inner case 11. An inner surface of the first insulating panel layer L1 may come into contact with the outer surface of the inner case 11.

The first insulating panel layer L1 may include some of the plurality of insulating panels 111. Some of the plurality of insulating panels 111 may be arranged along the edge of the inner case 11 to cover the inner case 11.

The second insulating panel layer L2 may cover the first insulating panel layer L1. An inner surface of the second insulating panel layer L2 may come into contact with an outer surface of the first insulating panel layer L1. In addition, an outer surface of the second insulating panel layer L2 may come into contact with the inner surface of the outer case 12.

The second insulating panel layer L2 may include others of the plurality of insulating panels 111. Others of the plurality of insulating panels 111 may be arranged along the outer surface of the first insulating panel layer L1 to cover the first insulating panel layer L1. In other words, others of the plurality of insulating panels 111 may be arranged along the edge of the outer case 12.

Although one embodiment, in which two insulating panel layers are provided, is described in the present disclosure, there is no specific limitation on the number of insulating panel layers. For example, one or three or more insulating panel layers may be provided.

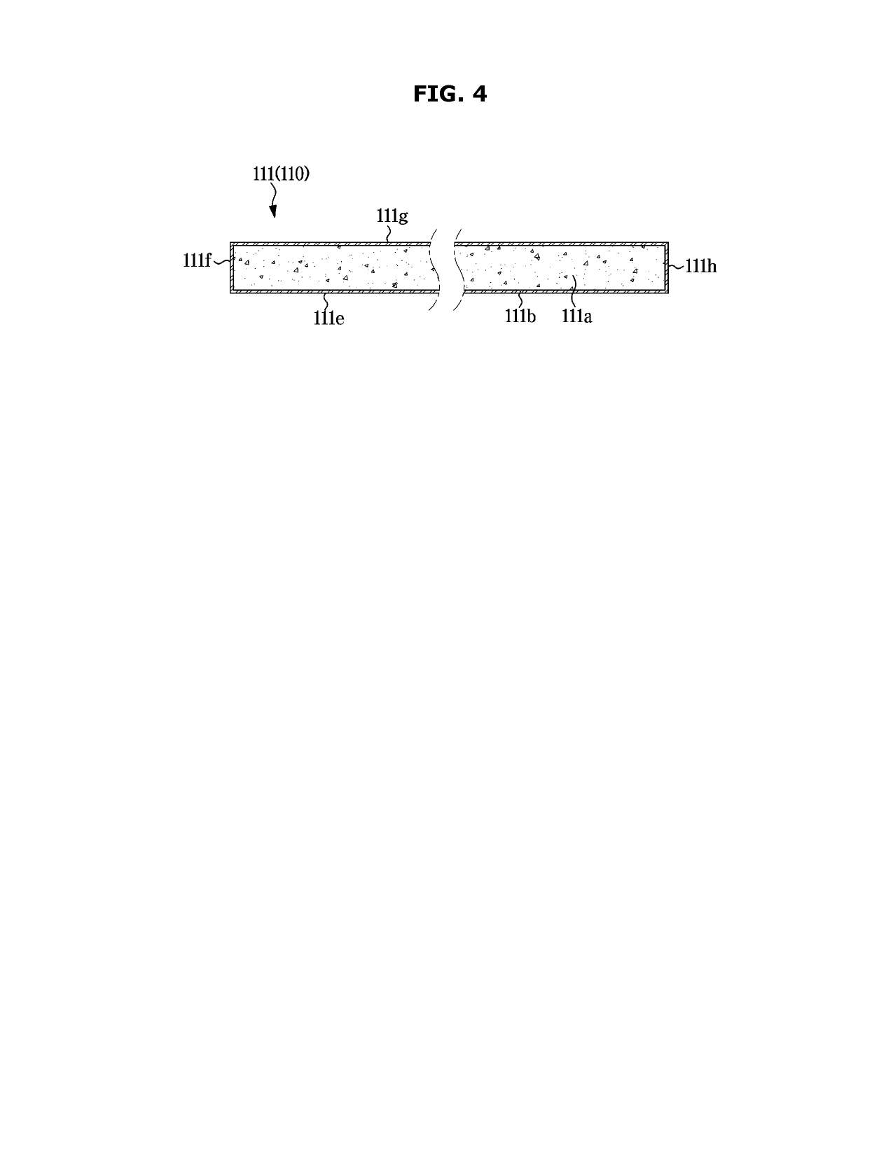

The insulating panel 111 may include a vacuum insulating panel 111. The vacuum insulating panel 111 may be one configuration having low thermal conductivity by utilizing a vacuum state in which heat transfer is minimized. The vacuum insulating panel 111 may include a core material 111a and an outer covering material 111b provided on an outside of the core material 111a to form a receiving space in which the core material 111a is received. An inside of the outer covering material 111b may be provided in a vacuum state or a state close to a vacuum (refer to FIG. 4).

The vacuum insulating panel 111 may have lower thermal conductivity than an insulating material formed by foaming, such as urethane. That is, a minimum volume of the vacuum insulating panel 111 required to obtain a predetermined level of insulation performance may be smaller than a minimum volume of the insulating material required to obtain the same level of insulation performance. Therefore, when the vacuum insulating panel 111 is arranged between the inner case 11 and the outer case 12 to insulate the storage compartment 20, a gap between the inner case 11 and the outer case 12 may be formed relatively smaller, and accordingly, a size of the storage compartment 20 may be formed larger.

At least some of the plurality of insulating panels 111 may be vacuum insulating panels 111. That is, some or all of the plurality of insulating panels 111 may be vacuum insulating panels 111. For convenience of description, in the present disclosure, it is assumed that all of the plurality of insulating panels 111 are provided as vacuum insulating panels 111. Accordingly, the insulating panel 111 and the vacuum insulating panel 111 may be respectively referred to by the same reference numerals.

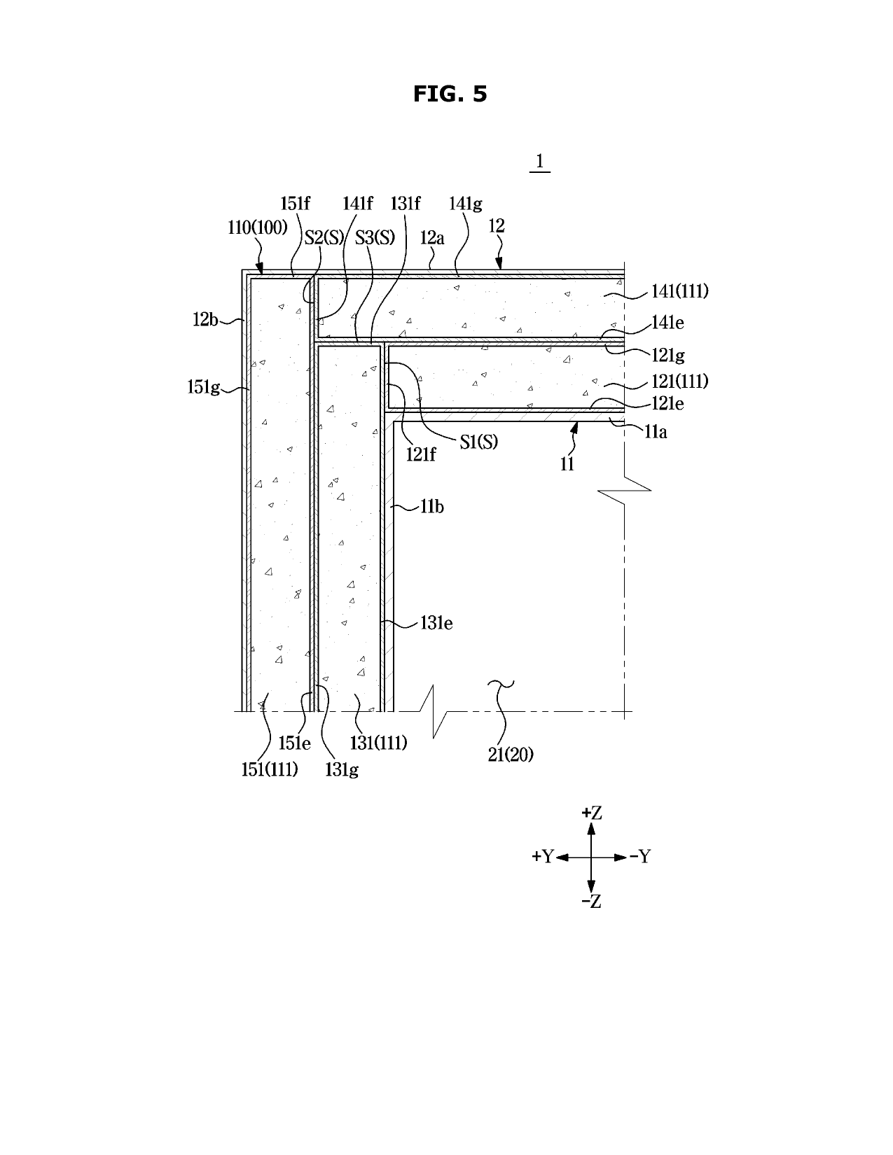

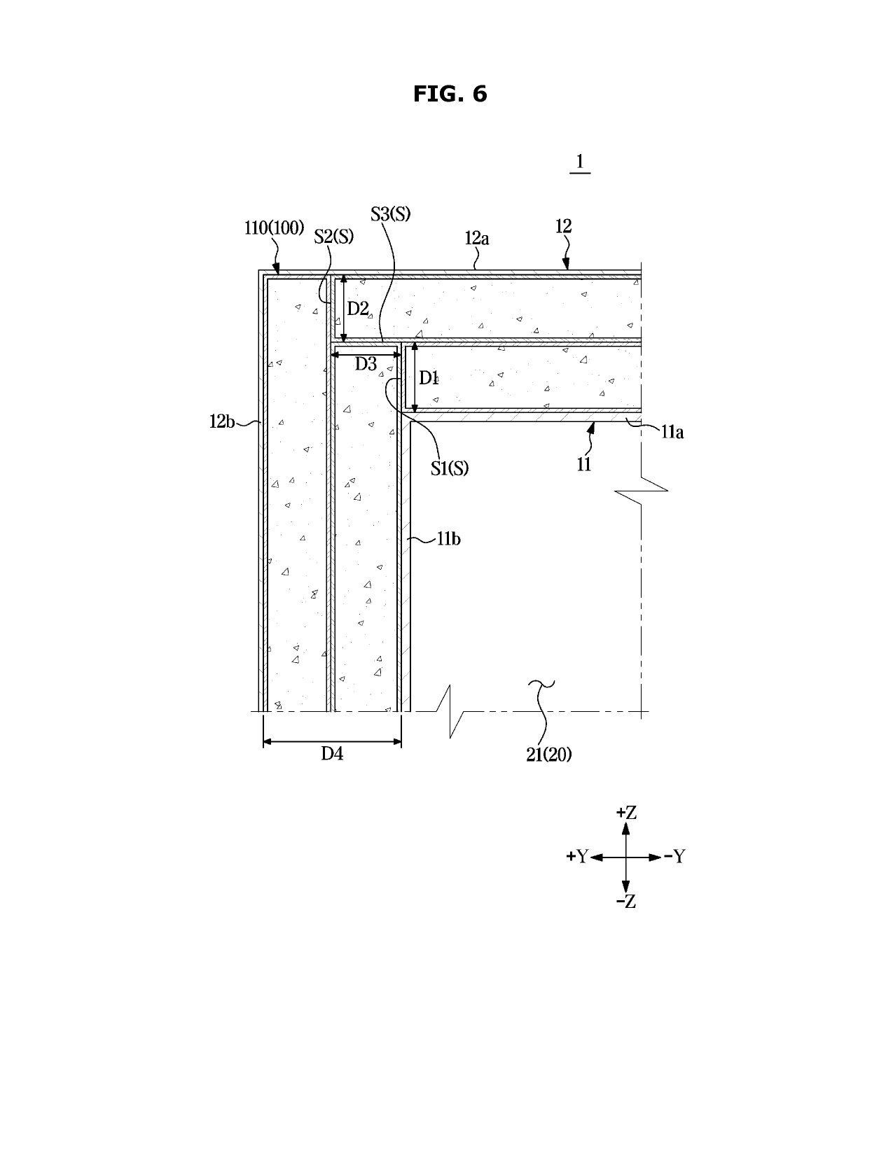

FIG. 4 is a cross-sectional view of an insulating panel according to one embodiment. FIG. 5 is an enlarged view of a region A illustrated in FIG. 3. FIG. 6 is an enlarged view of the region A illustrated in FIG. 3.

Referring to FIGS. 2, and 4 to 6, the insulating panel 111 may include a front surface 111c and a rear surface 111d. The front surface 111c and the rear surface 111d of the insulating panel 111 may be provided on opposite sides. The front surface 111c of the insulating panel 111 may face the front of the refrigerator 1, and the rear surface 111d of the insulating panel 111 may face the rear of the refrigerator 1.

The insulating panel 111 may include a first surface 111e. The first surface 111e of the insulating panel 111 may be provided between the front surface 111c and the rear surface 111d. The first surface 111e of the insulating panel 111 may extend along a direction in which the plurality of insulating members 110 is arranged. Particularly, the first surface 111e of the insulating panel 111 may extend along the upper wall, lower wall, left wall, and right wall of the inner case 11. The first surface 111e of the insulating panel 111 may face the inner case 11.

The insulating panel 111 may include a second surface 111f. The second surface 111f of the insulating panel 111 may be provided between the front surface 111c and the rear surface 111d. The second surface 111f of the insulating panel 111 may extend along a direction intersecting with the direction in which the plurality of insulating members 110 is arranged. In other words, the second surface 111f of the insulating panel 111 may extend along a direction intersecting with the direction in which the first surface 111e of the insulating panel 111 extends. For example, the second surface 111f of the insulating panel 111 may extend in a direction perpendicular to the direction in which the first surface 111e of the insulating panel 111 or a third surface 111g described later extends.

The insulating panel 111 may include the third surface 111g. The third surface 111g of the insulating panel 111 may be provided between the front surface 111c and the rear surface 111d. The third surface 111gof the insulating panel 111 may be provided on an opposite side of the first surface 111e. The third surface 111g of the insulating panel 111 may extend in the same direction as the first surface 111e extends. Particularly, the third surface 111g of the insulating panel 111 may extend along an upper wall, a lower wall, a left wall, and/or a right wall of the outer case 12. The third surface 111g of the insulating panel 111 may face the outer case 12.

The insulating panel 111 may include a fourth surface 111h. The fourth surface 111h of the insulating panel 111 may be provided between the front surface 111c and the rear surface 111d. The fourth surface 111h of the insulating panel 111 may be provided on the opposite side of the second surface 111f. The fourth surface 111h of the insulating panel 111 may extend in the same direction as the second surface 111f extends. For example, the fourth surface 111h of the insulating panel 111 may extend in a direction that perpendicularly intersects the direction in which the first surface 111e or the third surface 111g of the insulating panel 111 extends.

Based on a cross-section of the insulating panel 111 along the front and rear direction, each of the first surface 111e and the third surface 111g of the insulating panel 111 may form a long side having a relatively long length. Based on the cross-section of the insulating panel 111 along the front and rear direction, each of the second surface 111f and the fourth surface 111h of the insulating panel 111 may form a short side having a relatively short length.

Hereinafter the contact surface S formed by the plurality of insulating members 110 and a first insulating panel 121, a second insulating panel 131, a third insulating panel 141 and a fourth insulating panel 151, which are some of the plurality of insulating panels 111, will be described. At this time, a front surface, a rear surface, a first surface, a second surface, a third surface and a fourth surface provided on each of the first insulating panel 121, the second insulating panel 131, the third insulating panel 141 and the fourth insulating panel 151 may be the front surface 111c, the rear surface 111d, the first surface 111e, the second surface 111f, the third surface 111g and the fourth surface 111h of the insulating panel 111 described above.

At least some of the plurality of insulating members 110 may be provided to come into contact with each other so as to form the contact surface S. For example, at least some of the plurality of insulating panels 111 may be provided to come into contact with each other so as to form the contact surface S.

The contact surface S may include a plurality of contact portions. Each of the plurality of contact portions may be a contact surface formed between two insulating members 110 that come into contact with each other. That is, the contact portion may refer to one contact surface formed by two insulating members 110 that come into contact with each other, and the contact surface S may refer to an entire contact surface including all of the plurality of contact portions.

At least some of the plurality of contact portions may be connected to each other. For example, when three or more insulating members 110 are arranged to come into contact with each other, contact portions formed by the insulating members 110 may be connected to each other.

At least one of the plurality of contact portions may extend from the inner surface of the insulating pad 100 toward the outer surface of the insulating pad 100. In other words, the contact surface S may include a first contact portion S1 extending from the inner surface of the insulating pad 100 toward the outer surface of the insulating pad 100.

As described above, the inner surface of the insulating pad 100 may come into contact with the outer surface of the inner case 11. Accordingly, one end of the first contact portion S1 may be provided on the outer surface of the inner case 11.

At least one of the plurality of contact portions may extend from the outer surface of the insulating pad 100 toward the inner surface of the insulating pad 100. In other words, the contact surface S may include a second contact portion S2 extending from the outer surface of the insulating pad 100 toward the inner surface of the insulating pad 100.

As described above, the outer surface of the insulating pad 100 may come into contact with the inner surface of the outer case 12. Accordingly, one end of the second contact portion S2 may be provided on the inner surface of the outer case 12.

At least one of the plurality of contact portions may connect a contact portion extending from the inner surface of the insulating pad 100 toward the outer surface of the insulating pad 100 and a contact portion extending from the outer surface of the insulating pad 100 toward the inner surface of the insulating pad 100. In other words, the contact surface S may include a third contact portion S3 connecting the first contact portion S1 and the second contact portion S2.

The third contact portion S3 may extend in a direction intersecting with each of the first contact portion S1 and the second contact portion S2. That is, the third contact portion S3 may extend in a direction different from the direction in which each of the first contact portion S1 and the second contact portion S2 extends.

As described above, at least some of the plurality of insulating panels 111 may be provided to come into contact with each other so as to form the contact surface S. In other words, at least some of the plurality of insulating panels 111 may be provided to come into contact with each other so as to form the first contact portion S1, the second contact portion S2, and the third contact portion S3. For example, the plurality of insulating panels 111 may include the first insulating panel 121, the second insulating panel 131, the third insulating panel 141, and the fourth insulating panel 151 which are provided to come into contact with each other so as to form the first contact portion S1, the second contact portion S2, and the third contact portion S3.

Hereinafter the first contact portion S1, the second contact portion S2, and the third contact portion S3 will be described in more detail through the first insulating panel 121, the second insulating panel 131, the third insulating panel 141, and the fourth insulating panel 151.

The plurality of insulating panels 111 may include the first insulating panel 121. The first insulating panel 121 may cover a first side wall 11a of the inner case 11. For example, the first insulating panel 121 may cover an upper side wall (+Z direction) of the inner case 11.

A first surface 121e of the first insulating panel 121 may come into contact with the outer surface of the inner case 11. Particularly, the first surface 121e of the first insulating panel 121 may come into contact with an outer surface of the first side wall 11a of the inner case 11. For example, the first surface 121e of the first insulating panel 121 may come into contact with an outer surface of the upper side wall (+Z direction) of the inner case 11.

The plurality of insulating panels 111 may include the second insulating panel 131. The second insulating panel 131 may cover a second side wall 11b that is bent from the first side wall 11a of the inner case 11. For example, the second insulating panel 131 may cover the right wall (+Y direction) of the inner case 11.

A first surface 131e of the second insulating panel 131 may come into contact with the outer surface of the inner case 11. Particularly, the first surface 131e of the second insulating panel 131 may come into contact with an outer surface of the second side wall 11b of the inner case 11. For example, the first surface 131e of the second insulating panel 131 may come into contact with the outer surface of the right wall (+Y direction) of the inner case 11.

A second surface 121f of the first insulating panel 121 may come into contact with the first surface 131e of the second insulating panel 131. Particularly, a portion of the first surface 131e of the second insulating panel 131 may come into contact with the outer surface of the inner case 11, and other portion of the first surface 131e of the second insulating panel 131 may come into contact with the second surface 121f of the first insulating panel 121. With this configuration, the first contact portion S1 may be formed between the second surface 121f of the first insulating panel 121 and the first surface 131e of the second insulating panel 131.

The first contact portion S1 may come into contact with the outer surface of the inner case 11. In other words, one end of the first contact portion S1 may be provided on the outer surface of the inner case 11. Particularly, one end of the first contact portion S1 may be provided at a corner of the inner case 11.

The plurality of insulating panels 111 may include the third insulating panel 141. The third insulating panel 141 may be provided on the outer side of the first insulating panel 121. In other words, the third insulating panel 141 may be provided between a first side wall 12a of the outer case 12 and the first insulating panel 121. For example, the third insulating panel 141 may be provided between the upper side wall (+Z direction) of the outer case 12 and the first insulating panel 121.

A first surface 141e of the third insulating panel 141 may come into contact with a third surface 121g of the first insulating panel 121 and a second surface 131f of the second insulating panel 131. Particularly, a portion of the first surface 141e of the third insulating panel 141 may come into contact with the third surface 121g of the first insulating panel 121, and other portion of the first surface 141e of the third insulating panel 141 may come into contact with the second surface 131f of the second insulating panel 131. At this time, the third contact portion S3 may be formed between the first surface 141e of the third insulating panel 141 and the second surface 131f of the second insulating panel 131.

A third surface 141g of the third insulating panel 141 may come into contact with the inner surface of the outer case 12. Particularly, the third surface 141g of the third insulating panel 141 may come into contact with an inner surface of the first side wall 12a of the outer case 12. For example, the third surface 141g of the third insulating panel 141 may come into contact with the inner surface of the upper side wall (+Z direction) of the outer case 12.

The plurality of insulating panels 111 may include the fourth insulating panel 151. The fourth insulating panel 151 may be provided on the outer side of the second insulating panel 131. In other words, the fourth insulating panel 151 may be provided between the second insulating panel 131 and the second side wall 12b that is bent from the first side wall 12a of the outer case 12. For example, the fourth insulating panel 151 may be provided between the right wall (+Y direction) of the outer case 12 and the second insulating panel 131.

A first surface 151e of the fourth insulating panel 151 may come into contact with a third surface 131g of the second insulating panel 131 and a second surface 141f of the third insulating panel 141. Particularly, a portion of the first surface 151e of the fourth insulating panel 151 may come into contact with the third surface 131g of the second insulating panel 131, and other portion of the first surface 151e of the fourth insulating panel 151 may come into contact with the second surface 141f of the third insulating panel 141. At this time, the second contact portion S2 may be formed between the first surface 151e of the fourth insulating panel 151 and the second surface 141f of the third insulating panel 141.

The second contact portion S2 may come into contact with the inner surface of the outer case 12. In other words, one end of the second contact portion S2 may be provided on the inner surface of the outer case 12.

A second surface 151f of the fourth insulating panel 151 may come into contact with the inner surface of the outer case 12. Particularly, the second surface 151f of the fourth insulating panel 151 may come into contact with the inner surface of the first side wall 12a of the outer case 12. For example, a third surface 151g of the fourth insulating panel 151 may come into contact with the inner surface of the upper side wall (+Z direction) of the outer case 12.

The third surface 151g of the fourth insulating panel 151 may come into contact with the inner surface of the outer case 12. Particularly, the third surface 151g of the fourth insulating panel 151 may come into contact with the inner surface of the second side wall 12b of the outer case 12. For example, the third surface 151g of the fourth insulating panel 151 may come into contact with the inner surface of the right wall (+Y direction) of the outer case 12.

In the above-mentioned description, one embodiment, in which the first contact portion S1, the second contact portion S2, and the third contact portion S3 are formed by the first insulating panel 121, the second insulating panel 131, the third insulating panel 141, and the fourth insulating panel 151, has been described. Particularly, the first contact portion S1 may be formed between the second surface 121f of the first insulating panel 121 and the first surface 131e of the second insulating panel 131, the second contact portion S2 may be formed between the first surface 151e of the fourth insulating panel 151 and the second surface 141f of the third insulating panel 141, and the third contact portion S3 may be formed between the first surface 141e of the third insulating panel 141 and the second surface 131f of the second insulating panel 131.

With this configuration, the first contact portion S1 may be provided to extend from the inner surface of the insulating pad 100 toward the outer surface of the insulating pad 100, the second contact portion S2 may be provided to extend from the outer surface of the insulating pad 100 toward the inner surface of the insulating pad 100, and the third contact portion S3 may be provided to extend in a direction different from the extension direction of each of the first contact portion S1 and the second contact portion S2, thereby connecting the first contact portion S1 and the second contact portion S2. For example, the first contact portion S1 and the second contact portion S2 may each extend in the up and down direction (Z-axis direction), and the third contact portion S3 may extend in the left and right direction (Y-axis direction).

However, the extension directions of each of the first contact portion S1, the second contact portion S2, and the third contact portion S3 are not limited thereto. Alternatively, one embodiment, in which the first contact portion S1 and the second contact portion S2 extend in the left and right direction (Y-axis direction), and the third contact portion S3 extends in the up and down direction (Z-axis direction), may be possible.

As described above, the insulating panel 111 may be the vacuum insulating panel 111. The vacuum insulating panel 111 may include the core material 111a and the outer covering material 111b arranged on the outside of the core material 111a to form the receiving space in which the core material 111a is received. With this configuration, the contact surface S, which is formed as the plurality of insulating panels 111 comes into contact with each other, may be provided on the outer covering material 111b.

The outer covering material 111b may be provided as a deposited material, on which a metal or inorganic material having low gas and moisture permeability is deposited, or aluminum foil. That is, the outer covering material 111b may include a metal material having relatively high thermal conductivity. Therefore, when insulating the storage compartment 20 through the insulating panel 111, cold air inside the storage compartment 20 may leak out of the refrigerator 1 through the outer covering material 111b of the insulating panel 111.

For example, cold air inside the storage compartment 20 may leak out of the refrigerator 1 through the contact surface S. In other words, the contact surface S may form a cold air leakage path through which cold air inside the storage compartment 20 may leak. In this case, the cold air leakage path may be a path extending from the outer surface of the inner case 11 to the inner surface of the outer case 12 through some of the plurality of contact portions.

When cold air inside the storage compartment 20 leaks out of the refrigerator 1, the insulation performance and energy efficiency of the refrigerator 1 may deteriorate. In addition, dew formation on the outer wall of the refrigerator 1 may occur as the outer wall of the refrigerator 1 is cooled by the cold air that leaks out of the refrigerator 1.

However, when attempting to insulate the storage compartment 20 through the insulating panel 111, the contact surface S may inevitably be formed. This is because the insulating panel 111 may only be manufactured in a simple shape such as a rectangular parallelepiped, and thus it is required to place at least two insulating panels 111 to cover the space between the corner of the inner case 11 and the corner of the outer case 12. Therefore, when attempting to insulate the storage compartment 20 through the insulating panel 111, a method is required to minimize cold air leakage through the contact surface S in order to secure insulation performance and to improve energy efficiency.

According to the present disclosure, the cold air leakage path formed by the contact surface S may be longer than a distance in which the inner case 11 and the outer case 12 are spaced apart from each other. Particularly, the first contact portion S1, the second contact portion S2, and the third contact portion S3 described above may form the cold air leakage path, and the sum of a distance D1 in which the first contact portion S1 extends from the inner surface of the insulating pad 100, a distance D2 in which the second contact portion S2 extends from the outer surface of the insulating pad 100, and a distance D3 in which the third contact portion S3 extends from the first contact portion S1 to the second contact portion S2 may be greater than a distance D4 in which the inner case 11 and the outer case 12 are spaced apart from each other. That is, the cold air leakage path formed by the contact surface S may not extend in a straight line between the inner case 11 and the outer case 12, but may include at least one bending point. Accordingly, the cold air leakage path may be formed to be relatively long.

With this configuration, efficiency of cold air transmission through the cold air leakage path formed by the contact surface S may be reduced. Therefore, the insulation performance of the refrigerator 1 may be secured, energy efficiency may be improved, and dew formation on the outer wall of the refrigerator 1 may be prevented.

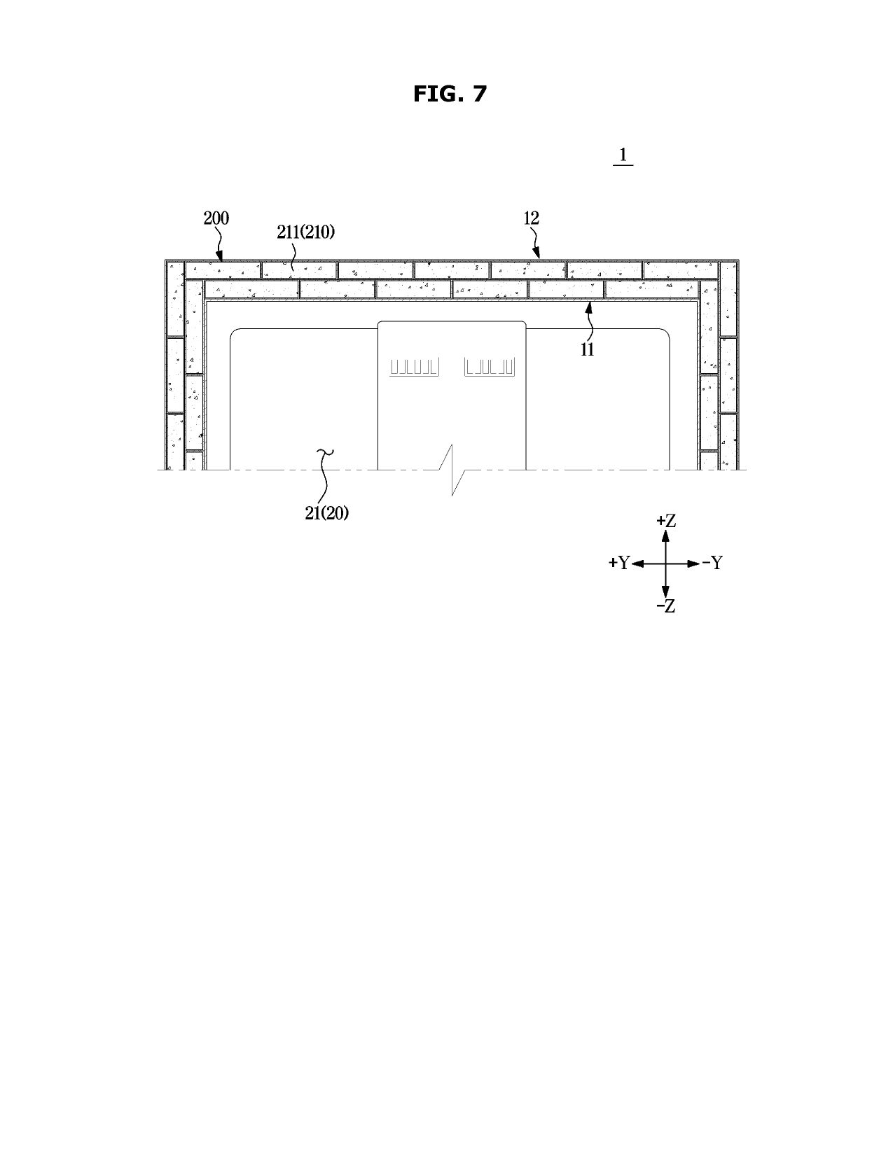

FIG. 7 is a cross-sectional view illustrating a state in which an inner case, an outer case, and an insulating pad of a refrigerator according to one embodiment are coupled to each other.

Hereinafter an insulating pad 200 according to one embodiment of the present disclosure will be described with reference to FIG. 7. In describing the insulating pad 200, components that are substantially the same as those illustrated in FIGS. 1 to 6 are assigned the same reference numerals, and a detailed description thereof may be omitted.

Referring to FIG. 7, the insulating pad 200 may be provided to insulate a storage compartment 20. The insulating pad 200 may be provided between an inner case 11 and an outer case 12.

The insulating pad 200 may include a plurality of insulating members 210. The plurality of insulating members 210 may be arranged along an edge of the inner case 11.

The plurality of insulating members 210 may include a plurality of insulating panels 211. The plurality of insulating panels 211 may be arranged along the edge of the inner case 11.

At least some of the plurality of insulating panels 211 may be stacked along a direction intersecting a direction in which the plurality of insulating members 210 is arranged. For example, two or more insulating panels 211 may be stacked between one wall of the inner case 11 and one wall of the outer case 12.

At least two of the plurality of insulating panels 211 may be arranged along one side wall of the inner case 11. In other words, at least two of the plurality of insulating panels 211 may be arranged along one side wall of the outer case 12. That is, the number of insulating panels 211 arranged along one side wall of the inner case 11 or one side wall of the outer case 12 between one side wall of the inner case 11 and one side wall of the outer case 12 may be provided in plurality.

For example, a shape and size of each of the plurality of insulating panels 211 may be formed identically. With this configuration, a manufacturing process of the plurality of insulating panels 211 may be further simplified, and a manufacturing process cost of the refrigerator 1 may be reduced.

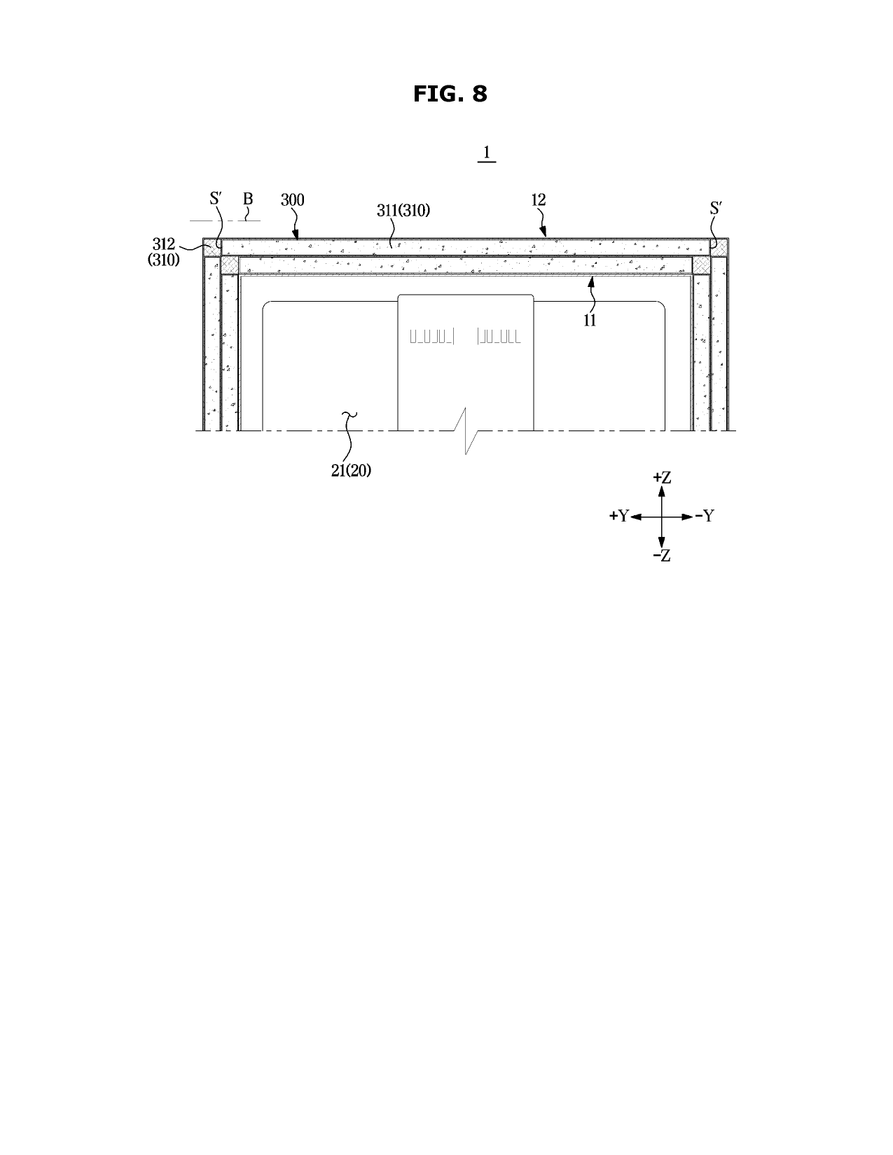

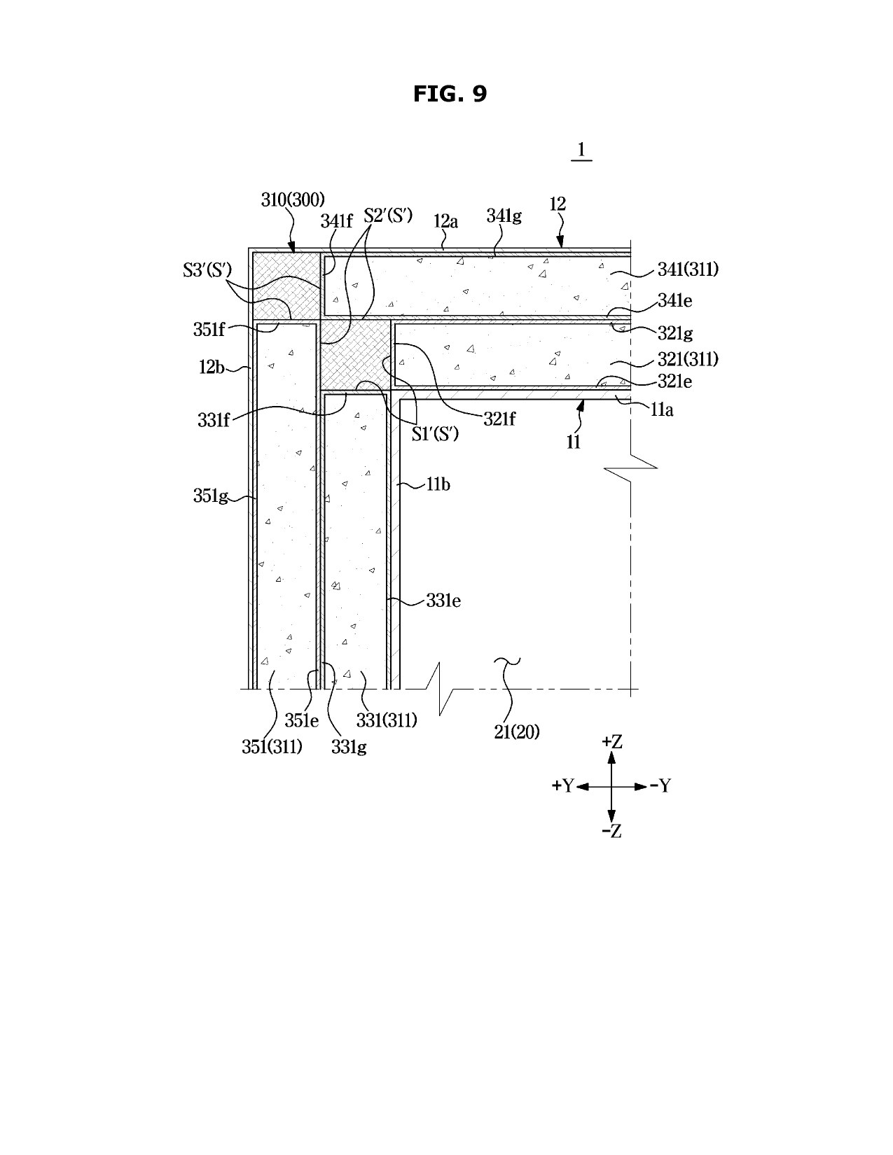

FIG. 8 is a cross-sectional view illustrating a state in which an inner case, an outer case, and an insulating pad of a refrigerator according to one embodiment are coupled to each other. FIG. 9 is an enlarged view of a region B illustrated in FIG. 8.

Hereinafter an insulating pad 300 according to one embodiment of the present disclosure will be described with reference to FIGS. 8 and 9. In describing the insulating pad 300, components that are substantially the same as those illustrated in FIGS. 1 to 6 are assigned the same reference numerals, and a detailed description thereof may be omitted.

Referring to FIGS. 8 and 9, the insulating pad 300 may be provided to insulate a storage compartment 20. The insulating pad 300 may be provided between an inner case 11 and an outer case 12.

The insulating pad 300 may include a plurality of insulating members 310. The plurality of insulating members 310 may be arranged along an edge of the inner case 11. At least some of the plurality of insulating members 310 may be stacked along a direction intersecting a direction in which the plurality of insulating members 310 is arranged. At least some of the plurality of insulating members 310 may be provided to come into contact with each other so as to form a contact surface S. The plurality of insulating members 310 may be bonded to each other so as to be provided integrally.

The plurality of insulating members 310 may include an insulating panel 311. For example, the insulating panel 311 may be a vacuum insulating panel 311 having low thermal conductivity by utilizing a vacuum state in which heat transfer is minimized. A plurality of insulating panels 311 may be provided.

The plurality of insulating members 310 may include an insulating material 312. For example, the insulating material 312 may be one of expanded polypropylene, expanded polystyrene, and expanded urethane. The insulating material 312 may be formed by foaming after the insulating panel 311 is installed between the inner case 11 and the outer case 12, or may be formed as a module integral with the insulating panel 311.

The plurality of insulating panels 311 and insulating material 312 may be arranged along the edge of the inner case 11. For example, based on a direction in which the plurality of insulating members 310 is arranged, the insulating material 312 may be provided between the plurality of insulating panels 311.

At least some of the plurality of insulating panels 311 and insulating materials 312 may be stacked along a direction intersecting the direction in which the plurality of insulating members 310 is arranged. With this configuration, the plurality of insulating panels 311 and insulating materials 312 may form a plurality of layers.

At least some of the plurality of insulating panels 311 and insulating materials 312 may be provided to come into contact with each other so as to form a contact surface S'. That is, at least some of the plurality of insulating panels 311 may be provided to come into contact with each other, and the insulating material 312 may be provided to come into contact with at least some of the plurality of insulating panels 311.

The contact surface S' may include a first contact portion S1' extending from an inner surface of the insulating pad 300 toward an outer surface of the insulating pad 300, a second contact portion S2' extending from the outer surface of the insulating pad 300 toward the inner surface of the insulating pad 300, and a third contact portion S3' extending in a direction intersecting each of the first contact portion S1' and the second contact portion S2' so as to connect the first contact portion S1' and the second contact portion S2'.

Hereinafter a first insulating panel 321, a second insulating panel 331, a third insulating panel 341, and a fourth insulating panel 351, which are some of the plurality of insulating panels 311, will be described. At this time, a front surface, a rear surface, a first surface, a second surface, a third surface and a fourth surface provided on each of the first insulating panel 321, the second insulating panel 331, the third insulating panel 341 and the fourth insulating panel 351 may be the front surface 111c, the rear surface 111d, the first surface 111e, the second surface 111f, the third surface 111g and the fourth surface 111h of the insulating panel 111 described with reference to FIGS. 2, and 4 to 6.

The plurality of insulating panels 311 may include the first insulating panel 321. The first insulating panel 321 may cover a first side wall 11a of the inner case 11. A first surface 321e of the first insulating panel 321 may come into contact with an outer surface of the first side wall 11a of the inner case 11.

The plurality of insulating panels 311 may include the second insulating panel 331. The second insulating panel 331 may cover a second side wall 11b that is bent from the first side wall 11a of the inner case 11. A first surface 331e of the second insulating panel 331 may come into contact with an outer surface of the second side wall 11b of the inner case 11.

The plurality of insulating panels 311 may include the third insulating panel 341. The third insulating panel 341 may be provided on the outside of the first insulating panel 321. A portion of a first surface 341e of the third insulating panel 341 may come into contact with a third surface 321g of the first insulating panel 321. Other portion of the first surface 341e of the third insulating panel 341 may be spaced apart from a second surface 331f of the second insulating panel 331.

A second surface 341f of the third insulating panel 341 may be spaced apart from a second side wall 12b of the outer case 12. The third surface 341g of the third insulating panel 341 may come into contact with the first side wall 12a of the outer case 12.

The plurality of insulating panels 311 may include the fourth insulating panel 351. The fourth insulating panel 351 may be provided on the outside of the second insulating panel 331. A portion of a first surface 351e of the fourth insulating panel 351 may come into contact with a third surface 331g of the second insulating panel 331. Other portion of the first surface 351e of the fourth insulating panel 351 may be spaced apart from a second surface 321f of the first insulating panel 321.

A second surface 351f of the fourth insulating panel 351 may be spaced apart from the first side wall 12a of the outer case 12. A third surface 351g of the fourth insulating panel 351 may come into contact with the second side wall 12b of the outer case 12.

A portion of the insulating material 312 may come into contact with the first insulating panel 321, the second insulating panel 331, the third insulating panel 341, and the fourth insulating panel 351. Particularly, a portion of the insulating material 312 may be surrounded by the second surface 321f of the first insulating panel 321, the second surface 331f of the second insulating panel 331, the first surface 341e of the third insulating panel 341, and the first surface 351e of the fourth insulating panel 351.

Other portion of the insulating material 312 may come into contact with the third insulating panel 341 and the fourth insulating panel 351. Particularly, other portion of the insulating material 312 may be surrounded by the second surface 341f of the third insulating panel 341, the second surface 351f of the fourth insulating panel 351, and the inner surface of the outer case 12.

A first contact portion S1' may be formed between a portion of the insulating material 312 and the second surface 321f of the first insulating panel 321. Additionally, other first contact portion S1' may be formed between a portion of the insulating material 312 and the second surface 331f of the second insulating panel 331.

A second contact portion S2' may be formed between other portion of the insulating material 312 and the second surface 341f of the third insulating panel 341. Additionally, other second contact portion S2' may be formed between other portion of the insulating material 312 and the second surface 351f of the fourth insulating panel 351.

A third contact portion S3' may be formed between a portion of the insulating material 312 and the first surface 341e of the third insulating panel 341. Additionally, other third contact portion S3' may be formed between a portion of the insulating material 312 and the first surface 351e of the fourth insulating panel 351.

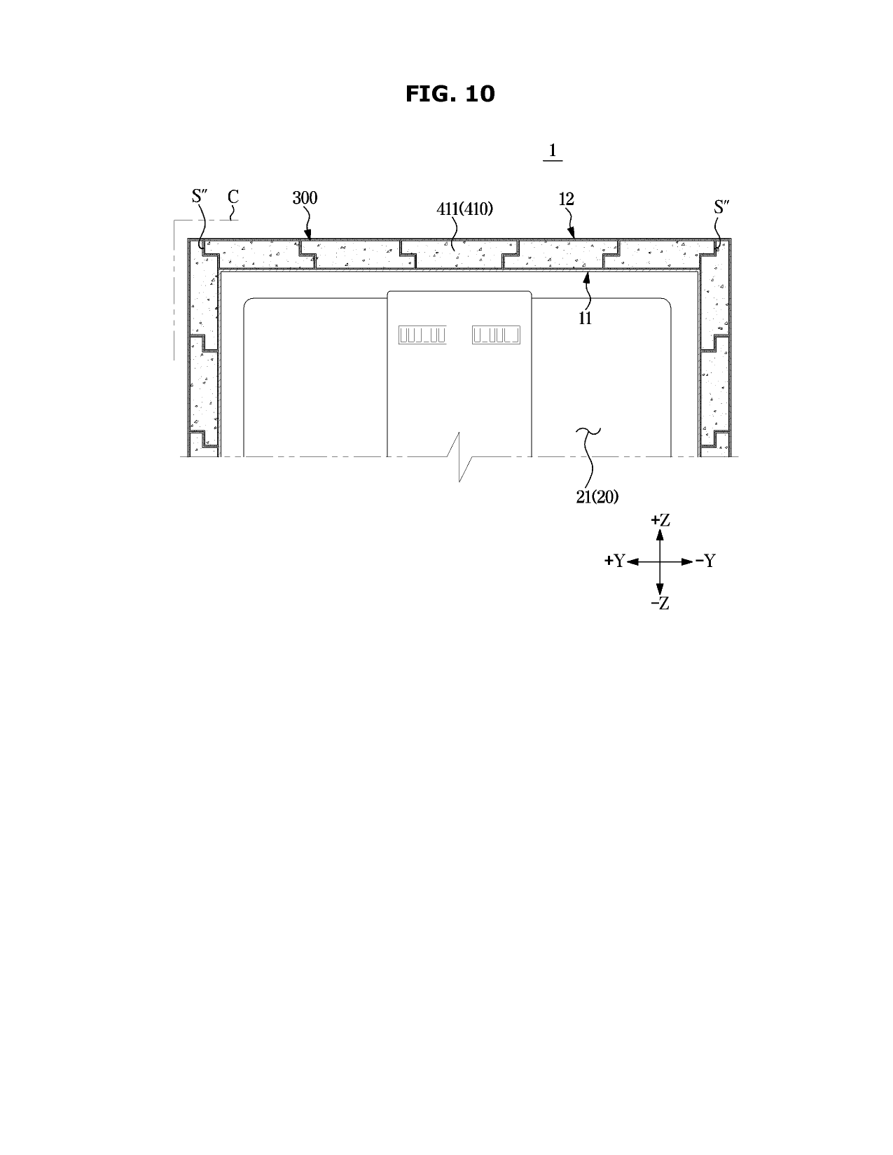

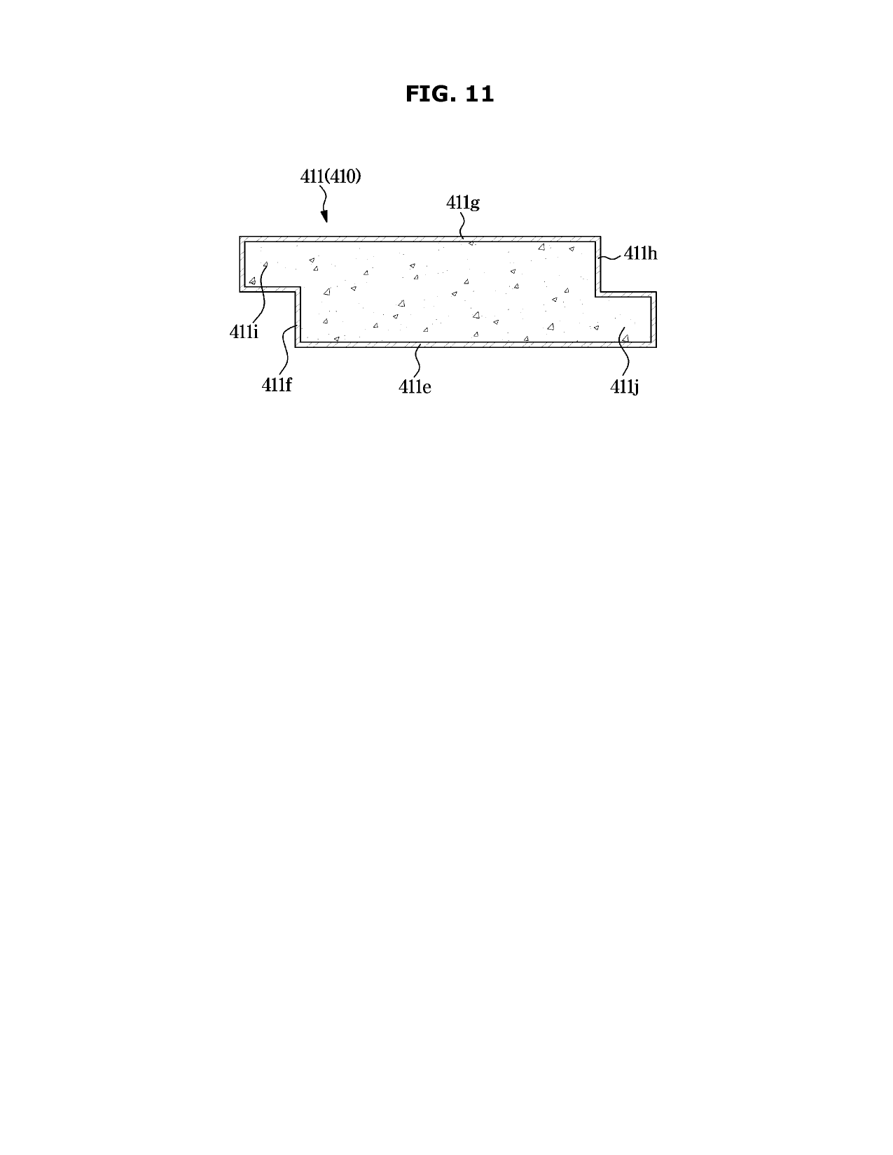

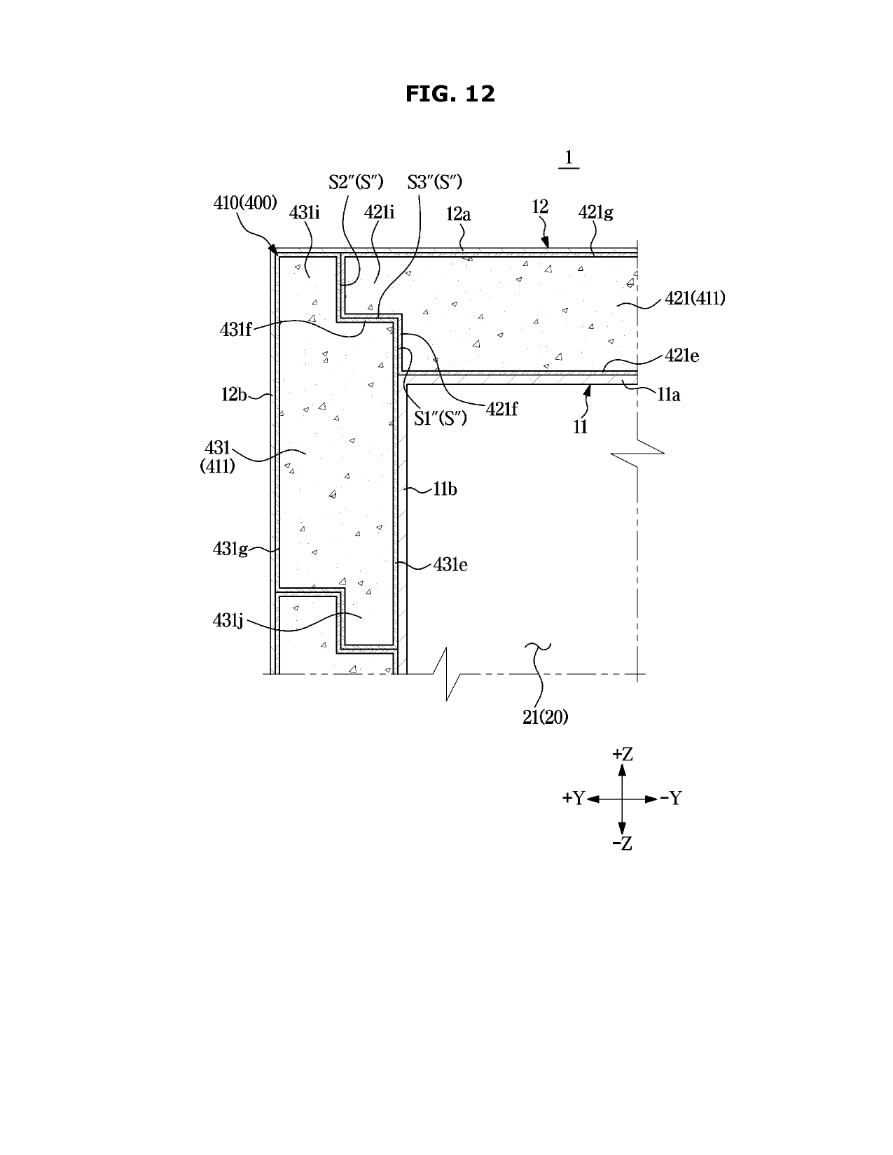

FIG. 10 is a cross-sectional view illustrating a state in which an inner case, an outer case, and an insulating pad of a refrigerator according to one embodiment are coupled to each other. FIG. 11 is a cross-sectional view of an insulating panel according to one embodiment. FIG. 12 is an enlarged view of a region C illustrated in FIG. 10.

Hereinafter an insulating pad 400 according to one embodiment of the present disclosure will be described with reference to FIGS. 10 to 12. In describing the insulating pad 400, components that are substantially the same as those illustrated in FIGS. 1 to 6 are assigned the same reference numerals, and a detailed description thereof may be omitted.

The insulating pad 400 may be provided to insulate a storage compartment 20. The insulating pad 400 may be provided between an inner case 11 and an outer case 12.

The insulating pad 400 may include a plurality of insulating members 410. The plurality of insulating members 410 may be arranged along an edge of the inner case 11. At least some of the plurality of insulating members 410 may be provided to come into contact with each other to form a contact surface S''.

The plurality of insulating members 410 may include a plurality of insulating panels 411. The plurality of insulating panels 411 may be arranged along the edge of the inner case 11.

At least two of the plurality of insulating panels 411 may be arranged along one side wall of the inner case 11. In other words, at least two of the plurality of insulating panels 411 may be arranged along one side wall of the outer case 12. That is, the number of insulating panels 411 arranged along one side wall of the inner case 11 or one side wall of the outer case 12 between one side wall of the inner case 11 and one side wall of the outer case 12 may be provided in plurality.

For example, a shape and size of each of the plurality of insulating panels 411 may be formed identically. With this configuration, a manufacturing process of the plurality of insulating panels 411 may be further simplified, and a manufacturing process cost of the refrigerator 1 may be reduced.

The insulating panel 411 may include a front surface, a rear surface, a first surface 411e, a second surface 411f, a third surface 411g, and a fourth surface 411h. At this time, each of the front surface, the rear surface, the first surface, the second surface, the third surface, and the fourth surface of the insulating panel 411 may be substantially the same as the front surface 111c, the rear surface 111d, the first surface 111e, the second surface 111f, the third surface 111g, and the fourth surface 111h of the insulating panel 111 described with reference to FIGS. 2 and 4 to 6.

The insulating panel 411 may include a first protrusion 411i protruding from the second surface 411f. The first protrusion 411i may include a first protrusion surface extending in the same direction as the first surface 411e, a second protrusion surface bent from the first protrusion surface and extending in the same direction as the second surface 411f, and a third protrusion surface bent from the first protrusion surface and extending in the same direction as the first surface 411e.

The insulating panel 411 may include a second protrusion 411j protruding from the fourth surface 411h. The second protrusion 411j may include a fourth protrusion surface extending in the same direction as the first surface 411e, a fifth protrusion surface bent from the fourth protrusion surface and extending in the same direction as the second surface 411f, and a sixth protrusion surface bent from the fifth protrusion surface and extending in the same direction as the first surface 411e.

Although it is illustrated that the first protrusion 411i and the second protrusion 411j are formed at different heights in FIG. 10, one embodiment, in which the first protrusion 411i and the second protrusion 411j are formed at the same height, may also be possible.

Hereinafter a first insulating panel 421 and a second insulating panel 431, which are some of the plurality of insulating panels 411, will be described. At this time, a front surface, a rear surface, a first surface, a second surface, a third surface, a fourth surface, a first protrusion, and a second protrusion may be the front surface, the rear surface, the first surface 411e, the second surface 411f, the third surface 411g, the fourth surface 411h, the first protrusion 411i, and the second protrusion 411j of the insulating panel 411 described above.

The plurality of insulating panels 411 may include the first insulating panel 421 and the second insulating panel 431 that are arranged to come into contact with each other. For example, the first insulating panel 421 and the second insulating panel 431 may come into contact with each other between a corner of the inner case 11 and a corner of the outer case 12.

At least one of a first protrusion 421i and a second protrusion (not shown) of the first insulating panel 421 may be arranged to come into contact with a first protrusion 431i and a second protrusion 431j of the second insulating panel 431. For example, the first protrusion 421i of the first insulating panel 421 and the first protrusion 431i of the second insulating panel 431 may come into contact with each other.

At least some of the plurality of insulating panels 411 may be provided to come into contact with each other to form a contact surface S''. The contact surface S'' may include a first contact portion S1'' extending from an inner surface of the insulating pad 400 toward an outer surface of the insulating pad 400, a second contact portion S2'' extending from the outer surface of the insulating pad 400 toward the inner surface of the insulating pad 400, and a third contact portion S3'' extending in a direction intersecting each of the first contact portion S1'' and the second contact portion S2'' so as to connect the first contact portion S1'' and the second contact portion S2''. For example, the first contact portion S1'', the second contact portion S2'', and the third contact portion S3'' may be formed as the first insulating panel 421 and the second insulating panel 431 come into contact with each other. Details thereof will be described later.

The first insulating panel 421 may cover the first side wall 11a of the inner case 11. A first surface 421e of the first insulating panel 421 may come into contact with the outer surface of the first side wall 11a of the inner case 11. A third surface 421g of the first insulating panel 421 may come into contact with the outer surface of the first side wall 12a of the outer case 12.

The second insulating panel 431 may cover the second side wall 11b that is bent from a first side wall 41a of the inner case 11. A first surface 431e of the second insulating panel 431 may come into contact with the outer surface of the second side wall 11b of the inner case 11. A third surface 431g of the second insulating panel 431 may come into contact with the outer surface of the second side wall 12a of the outer case 12.

A second surface 421f of the first insulating panel 421 may come into contact with the first surface 431e of the second insulating panel 431. Particularly, a portion of the first surface 431e of the second insulating panel 431 may come into contact with the outer surface of the inner case 11, and other portion of the first surface 431e of the second insulating panel 431 may come into contact with the second surface 421f of the first insulating panel 421. With this configuration, the first contact portion S1'' may be formed between the second surface 421f of the first insulating panel 421 and the first surface 431e of the second insulating panel 431.

The first protrusion 421i of the first insulating panel 421 and the second surface 431f of the second insulating panel 431 may come into contact with each other. The third contact portion S3'' may be formed between the first protrusion 421i of the first insulating panel 421 and the second surface 431f of the second insulating panel 431.

The first protrusion 421i of the first insulating panel 421 and the first protrusion 431i of the second insulating panel 431 may come into contact with each other. The second contact portion S2'' may be formed between the first protrusion 421i of the first insulating panel 421 and the first protrusion 431i of the second insulating panel 431.

A refrigerator 1 according to one embodiment includes an inner case 11 in which a storage compartment 20 is inside, an outer case 12 on an outside of the inner case 11, and an insulating pad 100, 200, 300, or 400 between the inner case 11 and the outer case 12, and including a plurality of insulating members 110, 210, 310, or 410 arranged along an edge of the inner case 11. At least one of the plurality of insulating members 110, 210, 310, or 410 is arranged to contact with at least one other of the plurality of insulating members 110, 210, 310, or 410 so as to form a contact surface S, S', or S''. The contact surface S, S', or S'' includes a first contact portion S1, S1', or S1'' extending from an inner surface of the insulating pad 100, 200, 300, or 400 in a first direction toward an outer surface of the insulating pad 100, 200, 300, or 400, a second contact portion S2, S2', or S2'' extending from the outer surface of the insulating pad 100, 200, 300, or 400 in a second direction opposite the first direction and toward the inner surface of the insulating pad 100, 200, 300, or 400, and a third contact portion S3, S3', or S3'' extending in a third direction intersecting the first contact portion S1, S1', or S1'' and intersecting the second contact portion S2, S2', or S2'' such that the first contact portion S1, S1', or S1'' and the second contact portion S2, S2', or S2'' connect to each other. The third direction is both perpendicular to the first direction and perpendicular to the second direction.

An inner surface of the insulating pad 100, 200, 300, or 400 may contact an outer surface of the inner case 11. An outer surface of the insulating pad 100, 200, 300, or 400 may contact an inner surface of the outer case 12.

An end of the first contact portion S1, S1', or S1'' may be at a corner of the inner case 11. An end of the second contact portion S2, S2', or S2'' may be on the inner surface of the outer case 12.

A sum of a distance D1 in which the first contact portion S1, S1', or S1'' extends from the inner surface of the insulating pad 100, 200, 300, or 400, a distance D2 in which the second contact portion S2, S2', or S2'' extends from the outer surface of the insulating pad 100, 200, 300, or 400, and a distance D3 in which the third contact portion S3, S3', or S3'' extends from the first contact portion S1, S1', or S1'' to the second contact portion S2, S2', or S2'' may be greater than a distance D4 in which the inner case 11 and the outer case 12 are spaced apart from each other.

The plurality of insulating members 110, 210, 310, or 410 may include a plurality of insulating panels 111, 211, 311, or 411 configured to contact each other. The plurality of insulating panels 111, 211, 311, or 411 may respectively include a front surface 111c, a rear surface 111d on an opposite side of the front surface 111c, a first surface 111e between the front surface 111c and the rear surfaces 111d and extending along a direction in which the plurality of insulating members 110, 210, 310, or 410 is arranged, a second surface 111f between the front surface 111c and the rear surfaces 111d and extending in a direction intersecting the direction in which the plurality of insulating members 110, 210, 310, or 410 is arranged, a third surface 111g provided on an opposite side of the first surface 111e, and a fourth surface 111h provided on an opposite side of the second surface 111f.

The plurality of insulating panels 111 may include a first insulating panel 121 covering a first side wall 11a of the inner case 11, and a second insulating panel 131 covering a second side wall 11b that is bent from the first side wall 11a of the inner case 12. A first surface 121e of the first insulating panel 121 and a first surface 131e of the second insulating panel 131 may contact the outer surface of the inner case 11. The first contact portion S1, S1', or S1'' may be formed as a second surface 121f of the first insulating panel 121 and the first surface 131e of the second insulating panel 131 contact each other.

The plurality of insulating panels 111 may further include a third insulating panel 141 on an outer side of the first insulating panel 121. A first surface 141e of the third insulating panel 141 may contact a third surface 121g of the first insulating panel 121 and a second surface 131f of the second insulating panel 131. The third contact portion S3, S3', or S3'' may be formed as the second surface 131f of the second insulating panel 131 and the first surface 141e of the third insulating panel 141 contact each other.

The plurality of insulating panels 111 may further include a fourth insulating panel 151 on an outer side of the second insulating panel 131. A first surface 151e of the fourth insulating panel 151 may contact with a third surface 131g of the second insulating panel 131 and a second surface 141f of the third insulating panel 141. The second contact portion S2, S2', or S2'' may be formed as the second surface 141f of the third insulating panel 141 and the first surface 151e of the fourth insulating panel 151 contact each other.

At least some of the plurality of insulating panels 111, 211, or 311 may be stacked along a direction intersecting the direction in which the plurality of insulating members 110, 210, or 310 is arranged.

The plurality of insulating panels 111, 211, 311, or 411 may include a vacuum insulating panel 111, 211, 311, or 411 including a core material 111a and an outer covering material 111b on an outside of the core material forming a receiving space in which the core material 111a is received.

The plurality of insulating members 110, 210, 310, or 410 may be integrally bonded to each other.

At least two of the plurality of insulating panels 211 may be arranged along one side wall of the inner case 11.

The plurality of insulating members 310 may further include an insulating material 312 to contact with at least one of the plurality of insulating panels 311.

The plurality of insulating panels 311 may include a first insulating panel 321 covering a first side wall 11a of the inner case 11 and a second insulating panel 331 covering a second side wall 11b that is bent from the first side wall 11a of the inner case 11. A portion of the insulating material 312 may be surrounded by a second surface 321f of the first insulating panel 321 and a second surface 331f of the second insulating panel 331.

Each of the plurality of insulating panels 411 may further include a first protrusion 411i protruding from the second surface 411f and a second protrusion 411j protruding from the fourth surface 411h. The plurality of insulating panels 411 may include a first insulating panel 421 and a second insulating panel 431 that are arranged to contact each other. At least one of a first protrusion 421i of the first insulating panel 421 and a second protrusion 421j of the first insulating panel 421 may be provided to contact with at least one of a first protrusion 431i of the second insulating panel 431 and a second protrusion 431j of the second insulating panel 431. Each of the first contact portion S1'', the second contact portion S2'', and the third contact portion S3'' may be formed when the first insulating panel 421 and the second insulating panel 431 contact with each other.

A refrigerator 1 according to one embodiment includes an inner case 11 in which a storage compartment 20 is provided, an outer case 12 provided on an outside of the inner case 11, and an insulating pad 100, 200, or 300 provided between the inner case 11 and the outer case 12, and including a plurality of insulating panel 111, 211, or 311 provided to come into contact with each other. The insulating pad 100, 200, or 300 includes a first insulating panel layer L1 including some of the plurality of insulating panels 111, 211, or 311, and provided to allow some of the plurality of insulating panels 111, 211, or 311 to be arranged along an edge of the inner case 11 to cover the inner case 11, and a second insulating panel layer L2 including others of the plurality of insulating panels 111, 211, or 311 and provided to allow others of the plurality of insulating panels 111, 211, or 311 to be arranged along an outer surface of the first insulating panel layer L1 to cover the first insulating panel layer L1.

An inner surface of the first insulating panel layer L1 may come into contact with an outer surface of the inner case 11. An outer surface of the second insulating panel layer L2 may come into contact with an inner surface of the outer case 12.

The insulating panel 111, 211, or 311 may include a vacuum insulating panel 111, 211, or 311 including a core material 111a and an outer covering material 111b provided on an outside of the core material to form a receiving space in which the core material 111a is received.

The plurality of insulating panels 111, 211, or 311 may be bonded to each other so as to be integrally provided.

The insulating pad 300 may further include an insulating material 312 provided to come into contact with at least some of the plurality of insulating panels 311.

As is apparent from the above description, a refrigerator may include an insulating pad in the form of a plurality of insulating members bonded to each other. That is, the plurality of insulating members may be modularized into a single insulating pad. Accordingly, an assembly process of the refrigerator may be further simplified.

Further, a refrigerator may form a relatively long path for heat to leak from a storage compartment to an outside of the refrigerator. With this configuration, the refrigerator may have high insulation properties and prevent dew formation on an outer wall due to heat leakage to the outside of the refrigerator.

Additional aspects of the disclosure will be set forth in part in the description which follows and, in part, will be obvious from the description, or may be learned by practice of the disclosure.

While the present disclosure has been particularly described with reference to exemplary embodiments, it should be understood by those of skilled in the art that various changes in form and details may be made without departing from the spirit and scope of the present disclosure.

1. A refrigerator comprising:
an inner case in which a storage compartment is inside;
an outer case on an outside of the inner case; and
an insulating pad, between the inner case and the outer case, including a plurality of insulating members arranged along an edge of the inner case,
wherein at least one of the plurality of insulating members is arranged to contact with at least one other of the plurality of insulating members so as to form a contact surface,
wherein the contact surface comprises:
a first contact portion extending from an inner surface of the insulating pad in a first direction toward an outer surface of the insulating pad;
a second contact portion extending from the outer surface of the insulating pad in a second direction opposite the first direction and toward the inner surface of the insulating pad; and
a third contact portion extending in a third direction intersecting the first contact portion and intersecting the second contact portion such that the first contact portion and the second contact portion connect to each other, wherein the third direction is both perpendicular to the first direction and perpendicular to the second direction.

2. The refrigerator of claim 1, wherein
an inner surface of the insulating pad contacts an outer surface of the inner case; and
an outer surface of the insulating pad contacts an inner surface of the outer case.

3. The refrigerator of claim 2, wherein
an end of the first contact portion is at a corner of the inner case; and
an end of the second contact portion is on the inner surface of the outer case.

4. The refrigerator of claim 1, wherein
a sum of a distance in which the first contact portion extends from the inner surface of the insulating pad, a distance in which the second contact portion extends from the outer surface of the insulating pad, and a distance in which the third contact portion extends from the first contact portion to the second contact portion is greater than a distance in which the inner case and the outer case are spaced apart from each other.

5. The refrigerator of claim 1, wherein
the plurality of insulating members includes a plurality of insulating panels configured to contact each other,
wherein the plurality of insulating panels respectively includes:
a front surface;
a rear surface on an opposite side of the front surface;
a first surface between the front surface and the rear surface and extending along a direction in which the plurality of insulating members is arranged;
a second surface between the front surface and the rear surface and extending in a direction intersecting the direction in which the plurality of insulating members is arranged;
a third surface on an opposite side of the first surface; and
a fourth surface on an opposite side of the second surface.

6. The refrigerator of claim 5, wherein
the plurality of insulating panels comprises:
a first insulating panel covering a first side wall of the inner case; and
a second insulating panel covering a second side wall that is bent from the first side wall of the inner case,
wherein a first surface of the first insulating panel and a first surface of the second insulating panel contact the outer surface of the inner case,
wherein the first contact portion is formed as a second surface of the first insulating panel and the first surface of the second insulating panel contact each other.

7. The refrigerator of claim 6, wherein
the plurality of insulating panels further comprises:
a third insulating panel on an outer side of the first insulating panel,
wherein a first surface of the third insulating panel contacts a third surface of the first insulating panel and a second surface of the second insulating panel,
wherein the third contact portion is formed as the second surface of the second insulating panel and the first surface of the third insulating panel contact each other.

8. The refrigerator of claim 7, wherein
the plurality of insulating panels further comprises:
a fourth insulating panel on an outer side of the second insulating panel,
wherein a first surface of the fourth insulating panel contacts a third surface of the second insulating panel and a second surface of the third insulating panel,
wherein the second contact portion is formed as the second surface of the third insulating panel and the first surface of the fourth insulating panel contact each other.

9. The refrigerator of claim 5, wherein
at least some of the plurality of insulating panels are stacked along a direction intersecting the direction in which the plurality of insulating members is arranged.

10. The refrigerator of claim 5, wherein
the plurality of insulating panels comprises a vacuum insulating panel including a core material and an outer covering material on an outside of the core material forming a receiving space in which the core material is received.

11. The refrigerator of claim 1, wherein
the plurality of insulating members is integrally bonded to each other.

12. The refrigerator of claim 5, wherein
at least two of the plurality of insulating panels are arranged along one side wall of the inner case.

13. The refrigerator of claim 5, wherein
the plurality of insulating members further includes an insulating material to contact with at least one of the plurality of insulating panels.

14. The refrigerator of claim 13, wherein
the plurality of insulating panels comprises:
a first insulating panel covering a first side wall of the inner case; and
a second insulating panel covering a second side wall, the second side wall being bent from the first side wall of the inner case,
wherein a portion of the insulating material is surrounded by a second surface of the first insulating panel and a second surface of the second insulating panel.

15. The refrigerator of claim 5, wherein
each of the plurality of insulating panels further comprises:
a first protrusion protruding from the second surface; and
a second protrusion protruding from the fourth surface,
wherein the plurality of insulating panels comprises a first insulating panel and a second insulating panel, the first insulating panel and the second insulating panel being arranged to contact each other,
wherein at least one of a first protrusion of the first insulating panel and a second protrusion of the first insulating panel contact with at least one of a first protrusion of the second insulating panel and a second protrusion of the second insulating panel,
wherein each of the first contact portion, the second contact portion, and the third contact portion is formed when the first insulating panel and the second insulating panel come into contact with each other.
